(19) United States
(12) Patent Application Publication
(10) Pub. No.: US 2019/0108729 A1
(43) Pub. Date: Apr. 11, 2019

(54) CONTROLLED ENTITY HYBRID GAME

(71) Applicant: Gamblit Gaming, LLC, Glendale, CA (US)

(72) Inventors: Miles Arnone, Sherborn, MA (US); Eric Meyerhofer, Pasadena, CA (US); Caitlyn Ross, Watertown, MA (US)

(21) Appl. No.: 16/209,942

(22) Filed: Dec. 4, 2018

Related U.S. Application Data
(63) Continuation-in-part of application No. 15/233,294, filed on Aug. 10, 2016, now abandoned.
Application No. 15/233,294 is a continuation of application No. 14/462,516, filed on Aug. 18, 2014, now Pat. No. 9,443,387.
Application No. 14/462,516 is a continuation of application No. 14/019,384, filed on Sep. 5, 2013, now Pat. No. 8,821,264.
Application No. 14/019,384 is a continuation of application No. PCT/US12/68739, filed on Dec. 10, 2012.
(60) Provisional application No. 61/630,371, filed on Dec. 9, 2011.

(51) Int. Cl. G07F 17/32; G07F 17/34

(52) U.S. Cl. CPC G07F 17/3244; G07F 17/326; G07F 17/32; G07F 17/3295; G07F 17/3209; G07F 17/3225; G07F 17/3218; G07F 17/34

(57) ABSTRACT

An electronic gaming machine of a controlled entity hybrid gaming system is disclosed. The electronic gaming machine includes a game world engine controller constructed to provide a randomly generated payout of real world credits from at least one wager in a gambling game, and an entertainment software engine controller constructed to execute an entertainment game providing outcomes based upon a player's skillful execution of the entertainment game, communicate to the game world engine controller, a gameplay gambling event occurrence based upon a player's instruction of a controlled entity to consume an enabling element of the entertainment game that triggers a wager in the gambling game.

### CROSS REFERENCE TO RELATED APPLICATIONS

This application is a continuation-in-part of U.S. application Ser. No. 15/233,294, filed Aug. 10, 2016, which is a continuation of U.S. patent application Ser. No. 14/462,516, filed Aug. 18, 2014, and issued as U.S. Pat. No. 9,443,387 on Sep. 13, 2016, which is a continuation of U.S. patent application Ser. No. 14/019,384, filed Sep. 5, 2013, and issued as U.S. Pat. No. 8,821,264 on Sep. 2, 2014, which is a continuation of Patent Cooperation Treaty Application No. PCT/US12/68739, filed on Dec. 10, 2012, which claims the benefit of U.S. Provisional Patent Application No. 61/630,371, filed on Dec. 9, 2011, the contents of each of which are hereby incorporated by reference in their entirety as if stated in full herein. This application also references Patent Cooperation Treaty Application No. PCT/US11/26768, filed Mar. 1, 2011, Patent Cooperation Treaty Application No. PCT/US11/63587, filed on Dec. 6, 2011, and Patent Cooperation Treaty Application No. PCT/US12/58156, filed on Sep. 29, 2012, the contents of each of which are hereby incorporated by reference in their entirety as if stated in full herein.

### FIELD OF THE INVENTION

Embodiments of the invention are generally related to data processing systems. More particularly, embodiments of the invention relate to data processing systems that implement hybrid gaming wagering processes.

### BACKGROUND

The gaming machine manufacturing industry has traditionally developed gaming machines with a simple gambling game. A simple gambling game is a game of chance where the outcome of the game is dependent solely on chance (such as a slot machine). A game of chance can be contrasted with a game of skill where the outcome of the game may depend upon a player's skill with the game. Simple gambling games are not as interactive and do not include graphics as sophisticated as an entertainment game, which may be a game of skill such as a video game.

For example, U.S. Pat. No. 6,905,405 to McClintic describes a simple gaming device provided with a central processor (CPU) operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, a physical button or a touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the player according to a payable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Operation of another simple gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal.

However, a need exists to implement more complex wagering processes and simple gaming devices are not capable of implementing these complex wagering processes. Various aspects and embodiments of the invention meet such a need.

### SUMMARY

Systems and methods in accordance with embodiments of the invention provide a controlled entity hybrid game. In one embodiment, an electronic gaming machine for a hybrid game having an entertainment game and an entertainment game, includes a processor, and a memory coupled to the processor, the memory having processor-executable instructions that when executed by the processor, cause the processor to: generate an entertainment user interface for the entertainment game for the hybrid game, determine an action taken by a controlled entity of the entertainment game as instructed by a player using the entertainment game user interface, determine a gambling game outcome using a random number generator for a wager of real world credit in the gambling game in response to the action taken by the controlled entity, generate a display of the gambling game outcome in a gambling game user interface for the gambling game of the hybrid game, determine a change in an attribute of an element of the entertainment game using the gambling outcome, generate a display in the entertainment game user interface of the change in the attribute of the element of the entertainment game; and execute the entertainment game based upon actions taken by the game world character instructed by the player using the element.

In another embodiment the element of the entertainment game is the controlled entity.

In yet another embodiment, the element of the entertainment game is an enabling element, and wherein the attribute is an amount of the enabling element.

In yet another embodiment, the change in the attribute is an increment in the amount of an enabling element on a positive gambling game outcome.

In yet another embodiment, the change in the attribute is an increment in the amount of an enabling element on a negative gambling game outcome.

In yet another embodiment, the change in the attribute is a decrement in the amount of an enabling element on a positive gambling game outcome.

In yet another embodiment, the change in the attribute is a decrement in the amount of an enabling element on a negative gambling game outcome.

In yet another embodiment, the element of the entertainment game is an actionable element and the change in the attribute is a restoration of the actionable element.

In yet another embodiment, the element of the entertainment game is an actionable element and the change in the attribute is a removal of the actionable element.

In yet another embodiment, the element of the entertainment game is a collective enabling element.

In yet another embodiment, the change in the attribute is a restoration of the collective enabling element.

In yet another embodiment, the change in the attribute is a removal of the collective enabling element.

In another embodiment, a hybrid gaming wagering electronic gaming machine includes an entertainment software engine controller constructed to receive one or more gambling game outcomes of a hybrid gaming wagering process from a game world engine controller, generate an interactive user interface using the one or more gambling game outcomes, detect player interactions of a player with the interactive user interface, determine one or more interactive intermediate states of the hybrid gaming wagering process based on the player interactions and the one or more gambling game outcomes, and communicate the one or more interactive intermediate states to the game world engine controller. The hybrid gaming wagering electronic gaming machine further includes the game world engine controller operatively connected to the entertainment software engine controller, wherein the game world engine controller includes a random number generator, and wherein the game world engine controller is constructed to generate one or more random numbers using the random number generator, generate the one or more gambling game outcomes using the one or more random numbers, determine one or more gambling game states of the hybrid gaming wagering process, communicate the one or more gambling game outcomes to the entertainment software engine controller, receive the one or more interactive intermediate states from the entertainment software engine controller, and determine a wagering outcome for the hybrid gaming wagering process using the intermediate states.

In another embodiment of the invention, a single game world engine controller may provide services to two or more entertainment software engine controllers, thus allowing a controlled entity hybrid gaming system to operate more efficiently over a large range of scaling.

In another embodiment of the invention, multiple types of entertainment software engine controllers using different operating systems may be interfaced to a single type of game world engine controller without requiring customization of the game world engine controller, thus improving the efficiency of the game world engine controller by reducing complexity associated with maintaining separate game world engine controllers for each type of entertainment software engine controller.

In another embodiment of the invention, an entertainment software engine controller may be provided as a player device under control of a player while maintaining the game world engine controller in an environment under the control of a regulated operator of wagering systems.

In another embodiment of the invention, data communicated between the controllers may be encrypted to increase security of the controlled entity hybrid gaming system.

In another embodiment of the invention, an entertainment game may require extensive processing resources from an entertainment software engine controller leaving few processing resources for the functions performed by a game world engine controller. By virtue of an architecture of some embodiments of the invention, processing loads may be distributed across multiple devices so that operations of the entertainment software engine controller may be dedicated to an entertainment game and the processes of the game world engine controller are not burdened by the requirements of the entertainment game.

In another embodiment of the invention, a controlled entity hybrid gaming system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many embodiments, one or more components of a controlled entity hybrid gaming system are distributed in close proximity to each other and communicate using a local area network and/or a communication bus. In several embodiments, an entertainment software engine controller and a game world engine controller of a controlled entity hybrid gaming system are in a common location. In some embodiments, a game world engine controller communicates with an external entertainment software engine controller. In various embodiments, these multiple controllers and subcontrollers can be constructed from or configured using a single device or a plurality of devices so that a controlled entity hybrid gaming system is executed as a system in a virtualized space such as, but not limited to, where a real world engine subcontroller and a game world engine controller are large scale centralized servers and are operatively connected to distributed entertainment software engine controllers via a wide area network such as the Internet or a local area network. In embodiments, the components of a controlled entity hybrid gaming system may communicate using a networking protocol or other type of device-to-device communications protocol.

In another embodiment of the invention, an entertainment software engine controller is an entertainment game server acting as a host for managing head-to-head player interactions over a network of interactive subcontrollers connected to the interactive server using a communication link. The interactive server provides a distributed environment where players can compete directly with one another and interact with other players.

### BRIEF DESCRIPTION OF THE DRAWINGS

FIG. 1 is block diagram of a controlled entity hybrid gaming system in accordance with various embodiments of the invention.

FIG. 2 is a diagram of a structure of a controlled entity hybrid gaming system in accordance with various embodiments of the invention.

FIG. 3A is a diagram of an electronic gaming machine configuration of a controlled entity hybrid gaming system in accordance with various embodiments of the invention.

FIG. 3B is a diagram of a table electronic gaming machine configuration of a controlled entity hybrid gaming system in accordance with various embodiments of the invention.

FIG. 3C is a diagram of a virtual reality gaming machine configuration of a controlled entity hybrid gaming system in accordance with various embodiments of the invention.

FIG. 4 is a diagram of distributed controlled entity hybrid gaming systems in accordance with various embodiments of the invention.

FIGS. 5A and 5B are diagrams of a structure of an entertainment software engine controller of a controlled entity hybrid gaming system in accordance with various embodiments of the invention.

FIG. 6 is a diagram of a structure of a game world engine controller of a controlled entity hybrid gaming system in accordance with various embodiments of the invention.

FIGS. 7A and 7B are sequence diagrams of interactions between components of a controlled entity hybrid gaming system in accordance with various embodiments of the invention.

FIG. 8 is a flow chart illustrating use of a controlled entity in accordance with an embodiment of the invention.

FIG. 9 is a flow chart illustrating another use of a controlled entity in accordance with an embodiment of the invention.

FIG. 10 is a flow chart illustrating another use of a controlled entity in accordance with an embodiment of the invention.

FIG. 11 is a flow chart illustrating another use of a controlled entity in accordance with an embodiment of the invention.

FIG. 12 is a flow chart illustrating another use of a controlled entity in accordance with an embodiment of the invention.

FIG. 13 is a flow chart illustrating another use of a controlled entity in accordance with an embodiment of the invention.

FIG. 14 is a flow chart illustrating another use of a controlled entity in accordance with an embodiment of the invention.

FIG. 15 is a flow chart illustrating another use of a controlled entity in accordance with an embodiment of the invention.

FIG. 16 is a flow chart illustrating another use of a controlled entity in accordance with an embodiment of the invention.

### DETAILED DESCRIPTION

Turning now to the drawings, systems and methods for operation of a controlled entity hybrid game are illustrated. In several embodiments, a controlled entity hybrid game is a form of a hybrid game that incorporates a controlled entity within an entertainment game portion of a hybrid game. The controlled entity is acted upon by a player and acts upon various classes of elements within the entertainment game portion of a hybrid game. When acted upon, these various elements trigger bets or wagers in a gambling game portion of the hybrid game. In certain embodiments, the controlled entity hybrid game also includes one or more user interfaces having displays associated with either or both the gambling game and the entertainment game. In operation of a controlled entity hybrid game, a player acts upon a controlled entity which in turn utilizes various types of elements of the entertainment game in a game world environment. Upon utilization of some of these elements, a wager is triggered in the gambling game. In playing the entertainment game, using the controlled entity, a player can consume and accrue game world credits (GWC) within the entertainment game. These credits can be in the form of (but are not limited to) game world objects, experience points, or points generally. Wagers are made in the gambling game using real world credits (RC). The real world credits can be credits in an actual currency, or may be credits in a virtual currency which has real world value. Gambling outcomes from the gambling game are used to determine consumption, loss, or accrual of RC. In addition, gambling outcomes in the gambling game may be used to determine a change in an attribute of one or more elements in the entertainment game such as (but not limited to) by adding an element, restoring a consumed element, causing the loss of an element, restoration of an element, or placement of an element. Example elements include (but are not limited to) enabling elements (EE) which are elements that enable a player's play of the entertainment game and whose consumption by the controlled entity while playing the entertainment game may trigger a wager in the gambling game. In addition, EE may also be replenished during play within the entertainment game based on a gambling game outcome of a triggered wager. Other types of elements include actionable elements (AE), which are elements that are acted upon to trigger a wager in the gambling game and may not be restorable during normal play of the entertainment game, and collective enabling elements (CEE). In some embodiments, a change in an attribute of a controlled entity is determined based on a gambling game outcome. Various hybrid games are discussed in Patent Cooperation Treaty Application No. PCT/US11/26768, filed Mar. 1, 2011, entitled “ENRICHED GAME PLAY ENVIRONMENT (SINGLE and/or MULTIPLAYER) FOR CASINO APPLICATIONS” and Patent Cooperation Treaty Application No. PCT/US11/63587, filed Dec. 6, 2011, entitled “ENHANCED SLOT-MACHINE FOR CASINO APPLICATIONS” each disclosure of which is hereby incorporated by reference in its entirety.

In many embodiments, a controlled entity hybrid game is a hybrid game incorporating controlled entities that are controlled by a player and act upon various types of elements in a hybrid game. A controlled entity hybrid game can be used to generate a rich gameplay experience. As is discussed further below, any of a variety of different controlled entity hybrid game scenarios can be utilized including (but not limited to) war themed controlled entity hybrid games, sports themed controlled entity hybrid games, and racing themed controlled entity hybrid games.

In many embodiments, a controlled entity hybrid game integrates high levels of entertainment content with a game of skill (entertainment game), a gambling experience with a game of chance (gambling game). A controlled entity hybrid game provides for random outcomes (gambling game outcomes) independently of player skill while providing that the user's gaming experience (as measured by obstacles/challenges encountered, time of play and other factors) is shaped by the player's skill.

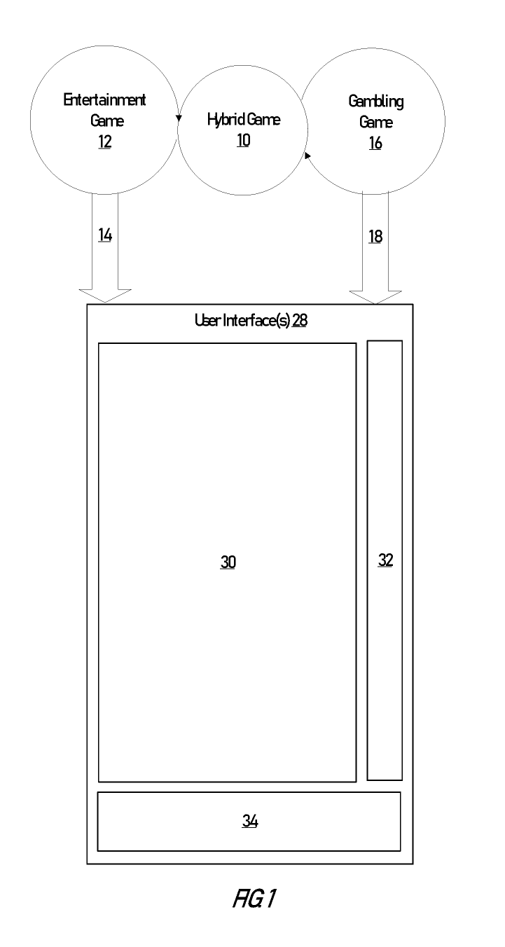

FIG. 1 is a block diagram illustrating a user interface and display of a controlled entity hybrid gaming system in accordance with various embodiments of the invention. A controlled entity hybrid gaming system includes a hybrid game 10 having an entertainment game 12 and a gambling game. The entertainment game 12 communicates entertainment game data 14 to one or more user interfaces 28 that are used to display to a player an interactive presentation generated based on the entertainment game data. The gambling game 16 communicates gambling game data 18 to the one or more user interfaces 28 that are used to display to the player an interactive presentation generated based on the gambling game data. By utilizing the one or more user interfaces and displays, the controlled entity hybrid gaming system can integrate entertainment game events and gambling game outcomes into a user interface and communicate a state of a hybrid gaming wagering process to the player all the while running seamlessly from the player's perspective.

The one or more user interfaces include one or more entertainment game user interface portions 30 having a display used to display to a player interactive objects that the player interacts with during gameplay of an entertainment game of a hybrid gaming wagering process. In many embodiments, the one or more user interfaces also include one or more gambling game user interface portions 34 having a display used to display to a player a status of a gambling game of a hybrid gaming wagering process. In many embodiments, the one or more user interfaces also include one or more gambling game process user interface portions 32 having a display used to display to a player a gambling game outcome generation process such as, but not limited to, a generation process of one or more gambling game outcomes.

In some embodiments, the controlled entity hybrid gaming system's user interfaces and associated displays allow transparent coupling of an entertainment game to wagering propositions, providing a seamless perspective to the player that they are playing an entertainment game. In accordance with some embodiments, a hybrid gaming wagering system can be used to enable a wide range of interactive video games including but not limited to popular titles from arcade and home video games, such as but not limited to, Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.).

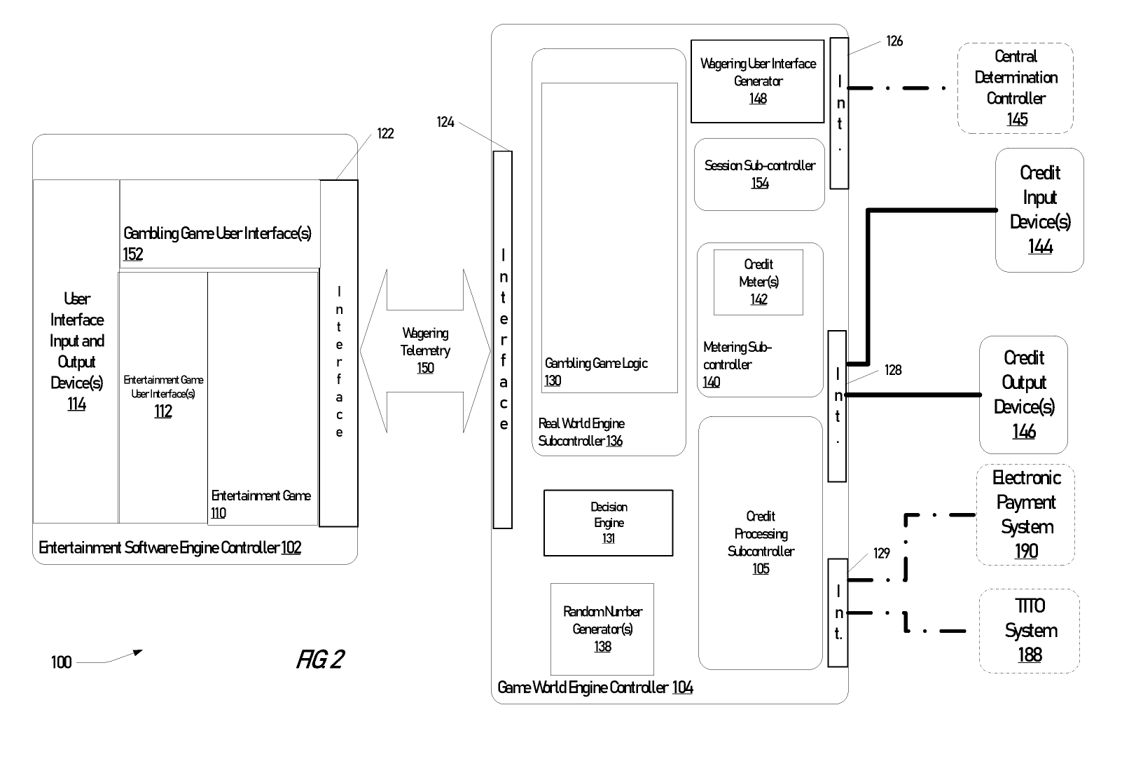

FIG. 2 is a diagram of an architecture of a controlled entity hybrid gaming system in accordance with various embodiments of the invention. The controlled entity hybrid gaming system is designed to implement a hybrid gaming wagering process through the initiation, detection, and processing of hybrid game events. The controlled entity hybrid gaming system 100 includes an entertainment software engine controller 102 and a game world engine controller 104. The game world engine controller 104 is also operatively connected to, and communicates with, various credit input and credit output devices and/or systems, such as one or more credit input devices 144, one or more credit output devices 146, a electronic payment system 190 and/or a ticket-in-ticket-out system 188, using a credit processing subcontroller 105.

In various embodiments, the entertainment software engine controller 102 detects player interactions with a hybrid gaming wagering process implemented by a controlled entity hybrid gaming system. The entertainment software engine controller 102 executes an entertainment game 110 and provides one or more user interface user input and output devices 114 so that one or more players can interact with the entertainment game 110. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The entertainment software engine controller 102 provides for player interactions with the entertainment game 110 by executing the entertainment game 110 that generates an interactive user interface 112 that utilizes the user input devices to detect player interactions with interactive elements of the entertainment game 110 of the entertainment software engine controller 102 and generates an interactive user interface that is presented to the player utilizing the user output devices.

In some embodiments, one or more components of an entertainment software engine controller are housed in an enclosure such as a housing, cabinet, casing or the like. The enclosure further includes one or more player accessible openings or surfaces constructed to mount the user input devices and/or the user output devices.

The entertainment software engine controller 102 is operatively connected to, and communicates with, the game world engine controller 104. The entertainment software engine controller 102 receives entertainment game resource data, as part of wagering telemetry data 150, including but not limited to, random number data from the game world engine controller 104.

In some embodiments, during execution of the entertainment game 110 by the entertainment software engine controller 102, the entertainment software engine controller 102 communicates, as part of wagering telemetry data 150, detected player interactions with one or more interactive elements of the interactive user interfaces 112 of the entertainment game 110, to the game world engine controller 104. The hybrid gaming wagering telemetry data may include, but is not limited to, entertainment game variables that indicate the state of the entertainment game 110, entertainment software engine controller data indicating a status of the entertainment software engine controller 102, detected player actions and interactions between one or more players and the entertainment game 110, one or more intermediate states of and/or one or more award states based on the detected player interactions with interactive elements of the entertainment game 110, and utilization of interactive elements of the entertainment game 110 by one or more players.

In some embodiments, the entertainment game 110 is a skill-based entertainment game, such as but not limited to a skill-based game. In embodiments, during execution of the skill-based entertainment game 110 by the entertainment software engine controller 102, the entertainment software engine controller 102 detects the players' skillful interaction with interactive elements of the entertainment game 110 during the players' skillful interaction with the skill-based entertainment game 110 to achieve an objective of the skill-based game. The game world engine controller 104 communicates with the entertainment software engine controller 102 in order to allow the coupling of the skill-based entertainment game 110 to gambling game outcomes generated in accordance with a hybrid gaming wagering process implemented by the game world engine controller 104 and/or the entertainment software engine controller 102.

In various embodiments, a controlled entity hybrid gaming system can include an entertainment game 110 that provides for player versus player (PvP) competitive play between a single player and a computing device, between two or more players against one another, or multiple players playing against a computing device and/or each other. In embodiments, gambling game outcomes of a hybrid gaming wagering process may be interjected into the competitive play to either enhance or disrupt one or more players' competitive play of the entertainment game 110.

In some embodiments, the entertainment software engine controller 102 includes one or more sensors (not shown) that sense various aspects of the physical environment of the entertainment software engine controller 102. Examples of sensors include, but are not limited to: global positioning sensors (GPSs) for sensing communications from a GPS system to detect a position or location of the entertainment software engine controller; temperature sensors; accelerometers; pressure sensors; and the like. Sensor telemetry data detected from the one or more sensors are communicated by the entertainment software engine controller to the game world engine controller 104 as part of the hybrid gaming wagering telemetry data 150.

In many embodiments, the entertainment software engine controller 102 includes one or more gambling game user interfaces 152 used to display wagering data, via one or more of the user interface input and output devices 114, to one or more players. The one or more gambling game user interfaces include a display to one or more players of various wagering data that may include, but is not limited to, an amount of credits committed to a wager, a denomination of a wager, an amount of credits won as the result of a successful wager, and an amount of credits in a credit meter associated with the one or more players.

In various embodiments, an entertainment game control interface 122 resident in the entertainment software engine controller 102 provides an interface between the entertainment software engine controller 102 and the game world engine controller 104 via interface 124.

In some embodiments, interfaces 122 and 124 implement an entertainment software engine controller to game world engine controller communication protocol employing an interprocess communication protocol so that an entertainment software engine controller and a game world engine controller may be implemented on the same device. In operation, the entertainment game control interface 122 provides application programming interfaces (APIs) that are used by an entertainment game of the entertainment software engine controller to communicate outgoing data and receive incoming data by passing parameter data to another process or application.

In some embodiments, interfaces 122 and 124 implement an entertainment software engine controller to game world engine controller communication protocol employing an interdevice communication protocol so that an entertainment software engine controller and a game world engine controller may be implemented on different devices. The interdevice protocol may utilize a wired communication bus or wireless network as a physical layer.

In various embodiments, interfaces 122 and 124 implement an entertainment software engine controller to game world engine controller communication protocol employing a networking protocol so that an entertainment software engine controller and a game world engine controller may be implemented on different devices connected by a network. The networking protocol may utilize a wired communication bus or wireless network as a physical layer. In many embodiments, the network includes a cellular telephone network or the like and the entertainment software engine controller is a mobile device such as a smartphone, tablet computer or other device capable of using the telephone network. During operation, the entertainment game control interface 122 communicates outgoing data to an external device by encoding the data into a signal and transmitting the signal to an external device. The entertainment game control interface receives incoming data from an external device by receiving a signal transmitted by the external device and decoding the signal to obtain the incoming data.

In several embodiments, interfaces 122 and 124 implement an encrypted communication protocol so that data communicated between the controllers may be encrypted to increase security of the controlled entity hybrid gaming system.

In various embodiments, the game world engine controller 104 includes a real world engine subcontroller 136 that uses gambling game logic 130, and one or more random number generators 138 to initiate random number generation by the random number generators and generate gambling game outcomes used by the controlled entity hybrid gaming system to perform a hybrid gaming wagering process.

In various embodiments, gambling game outcomes include, but are not limited to, gambling game outcomes that are an amount of credits or other items having value as described herein. The gambling game outcomes are generated in accordance with gambling game logic 130 and one or more outputs from the one or more random number generators 138.

In various embodiments, gambling game outcomes include, but are not limited to, resources of an entertainment game that a player uses and/or interacts with during interaction with the entertainment game as described herein. The resources are generated in accordance with resource logic and one or more outputs from the one or more random number generators 138.

In many embodiments, the real world engine subcontroller 136 of the game world engine controller 104 works in association with entertainment game 110. In an example embodiment, the real world engine subcontroller 136 uses an output of the one or more random number generators 138 to generate a random number. The random number is then communicated to the entertainment software engine controller 102, and the entertainment software engine controller uses the entertainment game 110 to generate one or more entertainment game resources.

In several embodiments, a rule-based decision engine 131 uses the hybrid gaming wagering telemetry data 150, one or more outputs of the one or more random number generators 138, along with gambling game logic 130, to generate one or more gambling game outcomes as described herein. In embodiments, a decision engine 131 includes one or more rules as part of gambling game logic 130 used by a decision engine 131 to determine how a gambling game outcome should be generated. Each rule includes one or more variable values constituting a pattern that is to be matched by the decision engine 131 to one or more variable values encoded in an input string of data. Each rule also includes one or more actions that are to be taken if the pattern is matched. Actions can include automatically generating one or more gambling game outcomes in accordance with the gambling game logic 130 as described herein. During operation, the game world engine controller 104 receives hybrid gaming wagering telemetry data 150 from the entertainment software engine controller 102. The real world engine subcontroller uses decision engine 131 to perform a matching process of matching the variable values encoded in the hybrid gaming wagering telemetry data 150 to one or more variable patterns of one or more rules. If a match between the variable values and a pattern of a rule is detected, then the real world engine subcontroller 136 performs the action of the matched rule.

In various embodiments, the game world engine controller communicates data of one or more gambling game outcomes generated by the real world engine subcontroller 136 to the entertainment software engine controller 102 as a portion of the entertainment game resource data communicated to the entertainment software engine controller 102.

In some embodiments, the decision engine 131 includes one or more rules as part of gambling game logic 130 used by the decision engine to automatically generate the entertainment game resource data that is then communicated to the entertainment software engine controller 102.

In some embodiments, the entertainment game 110 operates utilizing a scripting language. The entertainment game 110 parses scripts written in the scripting language and executes commands encoded in the scripts. In operation of embodiments, the game world engine controller 104 generates interactive entertainment game resource data in the form of scripts written in the scripting language that are communicated to the entertainment software engine controller 102 during execution of the entertainment game 110. The entertainment software engine controller 102 receives the scripts and passes the m to the entertainment game 110. The entertainment game 110 receives the scripts, parses the scripts and automatically executes the commands as encoded in the scripts.

In many embodiments, the entertainment game 110 automatically performs processes as instructed by commands communicated from the game world engine controller 104. The commands command the entertainment game 110 to perform specified operations such as executing specified commands and/or setting the values of variables utilized by the entertainment game 110. In operation of embodiments, the game world engine controller 104 generates commands that are encoded into the entertainment game resource data communicated to the entertainment software engine controller 102. The entertainment software engine controller 102 passes the entertainment game resource data to the entertainment game 110. The entertainment game parses the entertainment game resource data and automatically performs operations in accordance with the commands encoded in the entertainment game resource data.

In many embodiments, the game world engine controller 104 includes one or more interfaces, such as interface 126, that operatively connect the game world engine controller 104 to one or more external devices used to generate gambling game outcomes, such as central determination controller 145. In operation, when a real world engine subcontroller 136 of the game world engine controller 104 needs a gambling game outcome, the real world engine subcontroller communicates a request to the central determination controller 145 for the gambling game outcome. The central determination controller 145 receives the gambling game outcome request and generates a gambling game outcome in response to the gambling game outcome request. The central determination controller communicates data of the gambling game outcome to the game world engine controller 104. The game world engine controller 104 receives the data of the gambling game outcome and utilizes the gambling game outcome as described herein. In some embodiments, the gambling game outcome is drawn from a pool of pre-generated gambling game outcomes.

In various embodiments, the central determination controller 145 is a progressive controller that is operatively connected to a plurality of controlled entity hybrid gaming systems (not shown). The progressive controller provides services for the collection and provision of credits used by the game world engine controller 104 to provide wagering outcomes that have a progressive or pooling component.

In some embodiments, the game world engine controller 104 includes one or more interfaces, such as interface 128, that operatively connect the game world engine controller 104 to one or more credit input devices, such as credit input devices 144, and to one or more credit output devices, such as credit output devices 146.

In various embodiments, the game world engine controller 104 includes one or more interfaces, such as interface 129, that operatively connect the game world engine controller 104 to one or more ticket-in-ticket-out systems 188 and/or one or more electronic payment systems 190.

The game world engine controller 104 manages one or more wagers in accordance with one or more hybrid gaming wagering processes implemented by the controlled entity hybrid gaming system 100 by determining a commitment of a wager of value to the hybrid gaming wagering process, executing the hybrid gaming wagering process, and determining a wagering outcome of value of the hybrid gaming wagering process. Types of value committed to the one or more wagers can be one or more of several different types. In various embodiments, types of value of a wager can include, but are not limited to, a wager of an amount of credits corresponding to a real currency or a virtual currency, a wager of an amount of game world credit earned through interaction with an entertainment game, a wager of an amount of interactive elements of an entertainment game, and/or a wager of an amount of objects used in an entertainment game. In various embodiments, a type of value of a wagering outcome for a wager committed to a wagering process can be one or more of several different types. In various embodiments, types of value of a wagering outcome can include, but are not limited to, a wagering outcome of an amount of credits corresponding to a real currency or a virtual currency, a wagering outcome of an amount of GWC earned through interaction with an entertainment game, a wagering outcome of an amount of interactive elements of an entertainment game, and a wagering outcome of an amount of in-game objects used in an entertainment game.

In various embodiments, a type of value of a gambling game outcome of a hybrid gaming wagering process is different than a type of value of a wager commitment of the hybrid gaming wagering process. In an example embodiment, a value of a wager commitment can be an amount of credits, and a value of a wagering outcome can be an in-game object of an entertainment game.

In many embodiments, the game world engine controller 104 includes one or more random number generators (RNGs) having a known stochastic behavior 138 for generating non-deterministic random numbers having a known probability distribution. The real world engine subcontroller 136 uses outputs from the one or more random number generators 138 along with the gambling game logic 130 to generate one or more gambling game outcomes as described herein.

In many embodiments, the one or more random number generators 138 generate random numbers by continuously generating pseudorandom numbers using one or more pseudorandom number generators. A most current pseudorandom number is stored in a buffer thus constantly refreshing the buffer. In many embodiments, the buffer is refreshed at a rate of approximately 100 times per second. When the real world engine subcontroller 136 requests a random number to be used to generate a gambling game outcome, a random number generator outputs the stored most current pseudorandom number from the buffer. As timing between the requests for a random number is non-deterministic, the resulting output from the buffer is a true non-deterministic random number. In some embodiments, a random number generator includes a plurality of pseudorandom number generators that generate and store pseudorandom numbers into a respective plurality of buffers wherein each of the pseudorandom number generators is seeded with a different seed. When a request is made for a random number, the random number generator generates an additional pseudorandom number and on the basis of the additional pseudorandom number, randomly selects a respective buffer to output the requested random number. In some embodiments, a respective buffer is randomly chosen by hashing a value from a realtime clock circuit to create a random index value that is then used to select from between the respective buffers.

In some embodiments, an objective is generated by a controlled entity hybrid gaming system by executing objective generation commands included in objective logic that define processes of a hybrid gaming wagering process where the objective generation commands are formatted in a scripting language. In operation, a decision engine of a game world engine controller generates the objective generation commands in the form of a script written in the scripting language. The script includes the objective generation commands that describe how the real world engine subcontroller is to generate data of an objective. The real world engine subcontroller parses the script encoded in the objective generation command data and executes the commands included in the script to generate data of the objective.

In some embodiments, a gambling game outcome is generated by a controlled entity hybrid gaming system by executing gambling game outcome generation commands included in gambling game outcome logic to generate a random number and use the random number as in index into a lookup table having stored data of a plurality of gambling game outcomes.

In various embodiments, a game world engine controller uses a rule-based decision engine to automatically generate an amount of GWC to award to a player based at least in part on hybrid gaming wagering telemetry data including award state data and player interaction data with an entertainment game of the controlled entity hybrid gaming system. In numerous embodiments, the entertainment game is a skill-based entertainment game and the GWC are awarded for a player's skillful interaction with the entertainment game.

In several embodiments, the game world engine controller 104 includes a metering subcontroller 140. The metering subcontroller 140 communicates with the credit processing subcontroller 105 to receive incoming credit data from the credit processing subcontroller 105. The metering subcontroller 140 uses the incoming credit data to transfer credits into the controlled entity hybrid gaming system and onto one or more credit meters 142 associated with one or more players. The metering subcontroller 140 communicates outgoing credit data to the credit processing subcontroller 105 to transfer credits off of the one or more credit meters 142 and out of the controlled entity hybrid gaming system.

In various embodiments, the credit process subcontroller 105 and metering subcontroller 140 process types of value committed to the one or more wagers other than credits. In embodiments, the types of value can be one or more of several different types including, but not limited to, credits corresponding to a real currency or a virtual currency, GWC earned through interaction with an entertainment game, interactive elements of an entertainment game, and/or objects used in an entertainment game.

In some embodiments, the real world engine subcontroller 136 uses a gambling game user interface generator 148 to automatically generate wagering telemetry data 150 on the basis of amounts of credits on the one or more credit meters 142. The wagering telemetry data 150 is used by the game world engine controller 104 to command the entertainment software engine controller 102 to automatically generate one or more gambling game user interfaces 152 having a display describing a state of wagered credit accumulation and loss for the controlled entity hybrid gaming system. When a player interacts with the one or more gambling game user interfaces 152, gambling game user interface telemetry data 150 is generated by the one or more gambling game user interfaces 152 and communicated by the entertainment software engine controller 102 to the game world engine controller 104 using interfaces 122 and 124.

In some embodiments, the wagering telemetry data 150 may include, but is not limited to, amounts of GWC and interactive elements earned, lost or accumulated through interaction with the entertainment game 110, and credits, GWC and interactive elements amounts won, lost or accumulated.

In some embodiments, the entertainment game resource data are communicated to the gambling game user interface generator 148 and used as a partial basis for generation of the wagering telemetry data 150 communicated to the entertainment software engine controller 102.

In various embodiments, the gambling game user interface generator 148 also receives hybrid gaming wagering process state data that is used as a partial basis for generation of the wagering telemetry data 150 communicated to the entertainment software engine controller 102. In some embodiments, the hybrid gaming wagering process state data includes gambling game outcome data generated by the real world engine subcontroller 136 during the generation of gambling game outcomes. In various embodiments, the gambling game user interface generator 148 generates a gambling game outcome generation display using the one or more states of the hybrid gaming wagering process. The gambling game outcome generation display is included in the wagering telemetry data 150 that is communicated to the entertainment software engine controller 102. The gambling game outcome generation display is automatically displayed by the entertainment software engine controller 102 using the one or more gambling game user interfaces 152. In other embodiments, the hybrid gaming wagering process state data are communicated to the entertainment software engine controller 102 and the entertainment software engine controller 102 is instructed to automatically generate the gambling game outcome generation display of the one or more gambling game user interfaces 152.

In some embodiments, the hybrid gaming wagering process state data includes, but is not limited to, a final state, an intermediate state, a beginning state, and/or an award state of the hybrid gaming wagering process. For example, in a hybrid gaming wagering process that is based on slot machine math, the final state of the hybrid gaming wagering process may be reel positions, in a hybrid gaming wagering process that is based on roulette wheel math, the final state may be a pocket where a ball may have come to rest, in a hybrid gaming wagering process that is a based on card math, the beginning, intermediate and final states may represent a sequence of cards being drawn from a deck of cards, etc.

In some embodiments, an entertainment software engine controller generates a gambling game user interface by executing commands that define processes of the gambling game user interface where the commands are formatted in a scripting language. In operation, a gambling game user interface generator of a game world engine controller generates commands in the form of a script written in the scripting language. The script includes commands that describe how the entertainment software engine controller is to display hybrid gaming wagering process state data. The completed script is encoded as wagering telemetry data and communicated to the entertainment software engine controller by the game world engine controller. The entertainment software engine controller receives the wagering telemetry data and parses the script encoded in the wagering telemetry data and executes the commands included in the script to generate the gambling game user interface.

In many embodiments, an entertainment software engine controller generates a gambling game user interface based on a document written in a document markup language that includes commands that define processes of the gambling game user interface. In operation, a gambling game user interface generator of a game world engine controller generates a document composed in the document markup language. The document includes commands that describe how the entertainment software engine controller is to display hybrid gaming wagering process state data. The completed document is encoded as wagering telemetry data and communicated to the entertainment software engine controller by the game world engine controller. The entertainment software engine controller receives the wagering telemetry data and parses the document encoded in the wagering telemetry data and executes the commands encoded into the document to generate the gambling game user interface.

In some embodiments, an entertainment software engine controller generates a gambling game user interface by executing commands that define processes of the gambling game user interface. In operation, a gambling game user interface generator of a game world engine controller generates the commands and encodes the commands into wagering telemetry data that is communicated to the entertainment software engine controller by the game world engine controller. The entertainment software engine controller receives the wagering telemetry data and executes the commands encoded in the wagering telemetry data to generate the gambling game user interface.

In various embodiments, an entertainment software engine controller includes a data store of graphic display and audio presentation resources that the entertainment software engine controller uses to generate a gambling game user interface as described herein.

In many embodiments, a game world engine controller communicates graphic display and audio presentation resources as part of wagering telemetry data to an entertainment software engine controller. The entertainment software engine controller uses the graphic display and audio presentation resources to generate a gambling game user interface as described herein.

In various embodiments, the gambling game user interface generator 148 processes various types of value committed to one or more wagers. In embodiments, the types of value can be one or more of several different types including, but not limited to, credits corresponding to a real currency or a virtual currency, GWC earned through interaction with an entertainment game, interactive elements of an entertainment game, and/or objects used in an entertainment game.

In some embodiments, the game world engine controller 104 utilizes the one or more gambling game user interfaces 152 to display certain entertainment game data to the player, including but not limited to, club points, player status, control of the selection of choices, and messages which a player can find useful in order to adjust the entertainment game experience or understand the wagering status of the player.

In some embodiments, the game world engine controller 104 utilizes the one or more gambling game user interfaces 152 to display aspects of a hybrid gaming wagering process to a player including, but not limited to, amount of credits, GWC, interactive elements, or objects in play, and amounts of credits, GWC, interactive elements, or objects available.

In a number of embodiments, the real world engine subcontroller 136 can accept hybrid gaming wagering process factors including, but not limited to, modifications in the amount of credits, GWC, interactive elements, or objects wagered on each individual wagering event, entrance into a bonus round, and other factors. In several embodiments, the game world engine controller 104 can communicate a number of factors back and forth to the real world engine subcontroller, so that an increase/decrease in a wagered amount can be related to the change in player profile of the player in the entertainment game. In this manner, a player can control a wager amount per wagering event in accordance with the hybrid gaming wagering process with the change mapping to a parameter or component that is applicable to the entertainment game experience.

In some embodiments, the game world engine controller 104 includes a session subcontroller 154 is used to regulate a controlled entity hybrid gaming system session. In various embodiments, components of the game world engine controller 104 communicate session data to the session subcontroller 154. The session data may include, but is not limited to, player data, entertainment software engine controller data, pooled bet and side bet data, game world engine controller data and real world engine subcontroller data used by the session subcontroller to regulate a controlled entity hybrid gaming system session.

In some embodiments, the session subcontroller 154 may also assert control of a controlled entity hybrid gaming system session by communicating session control data to components of the game world engine controller 104. Such control may include, but is not limited to, commanding the game world engine controller 104 to end a controlled entity hybrid gaming system session, initiating wagering in a controlled entity hybrid gaming system session, ending wagering in a controlled entity hybrid gaming system session but not ending a player's use of the entertainment game portion of the controlled entity hybrid gaming system, and changing from real credit wagering in a controlled entity hybrid gaming system to virtual credit wagering, or vice versa.

In many embodiments, the session subcontroller 154 manages player profiles for a plurality of players. The session subcontroller 154 stores and manages data about players in order to provide authentication and authorization of players of the controlled entity hybrid gaming system 100. In some embodiments, the session subcontroller 154 also manages geolocation information to ensure that the controlled entity hybrid gaming system 100 is only used by players in jurisdictions were wagering is approved. In various embodiments, the session subcontroller 154 stores GWC that are associated with the player's use of the entertainment game of the controlled entity hybrid gaming system 100.

In some embodiments, the session subcontroller 154 communicates player and session management data to the player using a management user interface (not shown) of the entertainment software engine controller. The player interacts with the management user interface and the management user interface generates management telemetry data that is communicated to the session subcontroller 154.

In some embodiments, the real world engine subcontroller 136 communicates wagering session data to the session subcontroller 154. In various embodiments, the session subcontroller communicates wagering session control data to the real world engine subcontroller 136.

In many embodiments, the credit processing subcontroller 105 operatively connects to one or more credit input devices for generating incoming credit data from a credit input. Credit inputs can include, but are not limited to, credit items used to transfer credits. The incoming credit data are communicated by the credit processing subcontroller 105 to the metering subcontroller 140. In various embodiments, the one or more credit input devices and the it corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing subcontroller 105 includes one or more credit output devices 146 for generating a credit output based on outgoing credit data 192 communicated from the real world engine subcontroller. Credit outputs can include, but are not limited to, credit items used to transfer credits. Types of credit output devices and the it corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing subcontroller 105 is operatively connected to, and communicates with, a TITO system 188 or the like to determine incoming credit data representing amounts of credits to be transferred into the controlled entity hybrid gaming system and to determine outgoing credit data representing amounts of credits to be transferred out of the controlled entity hybrid gaming system. In operation, the credit processing subcontroller 105 communicates with a connected credit input device, such as a bill validator/ticket scanner, used to scan a credit input in the form of a TITO ticket having indicia of credit account data of a credit account of the TITO system. The credit processing subcontroller 105 communicates the credit account data to the TITO system. The TITO system uses the credit account data to determine an amount of credits to transfer to the credit processing subcontroller 105, and thus to the metering subcontroller 140 of the game world engine controller 104. The TITO system communicates the amount of credits to the credit processing subcontroller 105. The credit processing subcontroller 105 communicates the amount of credits as incoming credit data to the metering subcontroller 140 and the metering subcontroller 140 credits one or more credit meters 142 with the amount of credits so that the credits can be used when a player makes wagers using the controlled entity hybrid gaming system 100.

In many embodiments, the credit processing subcontroller 105 is operatively connected to a bill validator/ticket scanner as one of the one or more credit input devices 144. The credit processing subcontroller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the controlled entity hybrid gaming system 100.

In some embodiments, the credit processing subcontroller 105 can use a TITO system along with a ticket or voucher printer as one of the one or more credit output devices 146 to generate a TITO ticket as a credit output for a player. In operation, the credit processing subcontroller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing subcontroller 105. The credit processing subcontroller 105 uses the ticket or voucher printer to print indicia of the credit account data onto a TITO ticket or voucher as a credit output.

In various embodiments, the credit processing subcontroller 105 provides an interface to an electronic payment management system 190 such as an electronic wallet or the like. The electronic payment system provides credit account data that is used for generating incoming credit data as a credit input and outgoing credit data as a credit output.

In several embodiments, during operation, the metering subcontroller 140 communicates with the credit processing subcontroller 105 to receive incoming credit data from the credit processing subcontroller 105 and adds credits onto the one or more credit meters 110 at least partially on the basis of the incoming credit data. The real world engine subcontroller 136 uses the interactive gambling game logic 130 and outputs from the one or more random number generators 138 to generate one or more gambling game outcomes. Data of the one or more gambling game outcomes are communicated by the game world engine controller 104, as part of the entertainment game resource data, to the entertainment software engine controller 102. The entertainment game 110 uses the gambling game outcome data to generate an interactive user interface for the player including the one or more interactive user interfaces 112. One or more players interact with the one or more interactive user interfaces 112 through the one or more user interface input and output devices 114. The entertainment game 110 detects the player interactions and determines an award state based on the detected interactions of the one or more players using the hybrid gaming wagering process logic 116 and communicates data of the award state as part of the hybrid gaming wagering telemetry data 150 to the game world engine controller 104. The real world engine subcontroller 136 receives the award state data and determines a wagering outcome based on the award state data, and instructs the metering subcontroller 140 to add credits to, or deduct credits from, the one or more credit meters 110 based in part on the wagering outcome data. For example, in some embodiments, the metering subcontroller is instructed to add an amount of credits to a credit meter of the one or more credit meters 110 when the wagering outcome indicates a win for a player associated with the credit meter. In various embodiments, the metering subcontroller is instructed to deduct an amount of credits from the credit meter when the wagering outcome data indicates a loss for the player. At an end of a wagering session, the metering subcontroller 140 transfers credits off of the one or more credit meters 110 and out of the controlled entity hybrid gaming system by communicating outgoing credit data to the credit processing subcontroller 105. The credit processing subcontroller 105 uses the outgoing credit data to generate one or more credit output items using the one or more credit output devices 146.

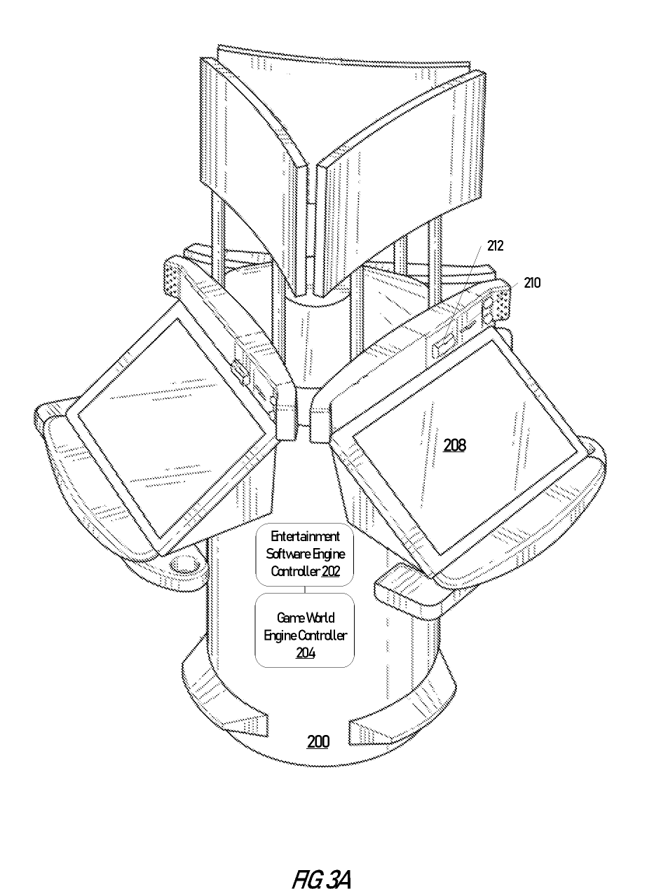

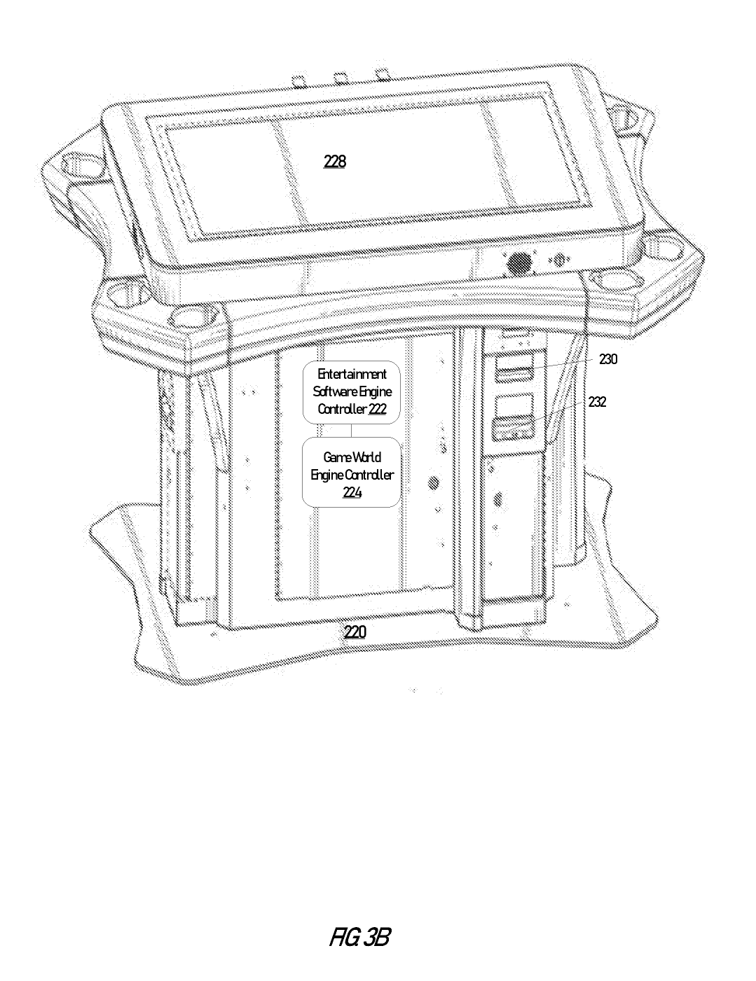

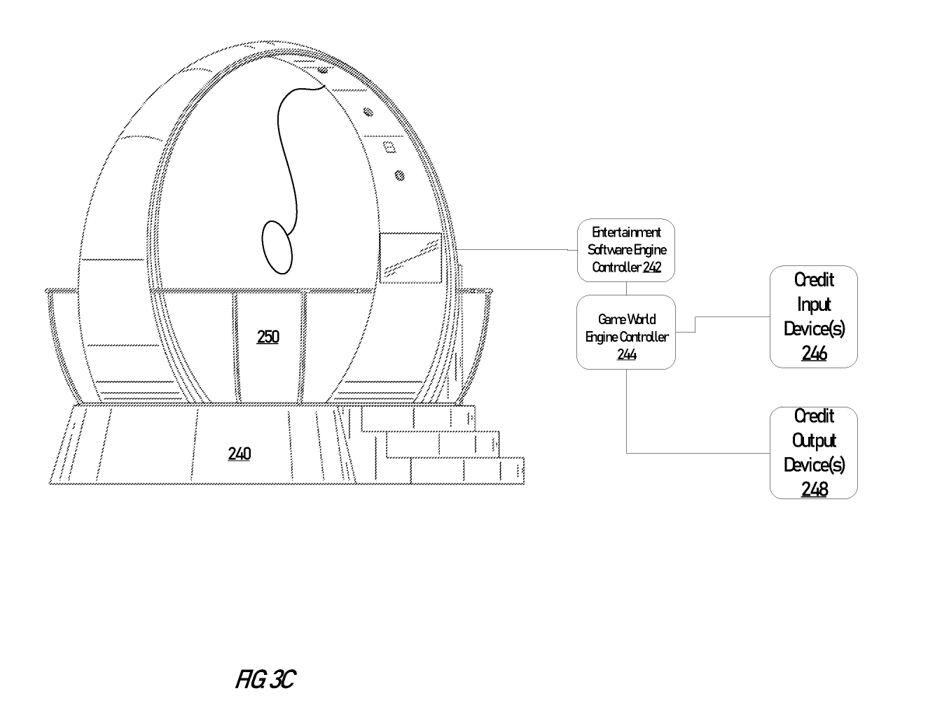

FIG. 3A is a diagram of an electronic gaming machine configuration of a controlled entity hybrid gaming system in accordance with various embodiments of the invention. Electronic gaming machine configurations of a controlled entity hybrid gaming system include, but are not limited to, electronic gaming machines such as slot machines, table games, video arcade consoles and the like. An electronic gaming machine configuration of a controlled entity hybrid gaming system 200 includes an entertainment software engine controller 202 as described herein and a game world engine controller 204 as described herein contained in an enclosure such as a housing, cabinet, casing or the like. The enclosure may further include one or more player accessible openings or surfaces that may be used to mount one or more player accessible user input devices and user output devices 208 as described herein, one or more player accessible credit input devices 210 and one or more player accessible credit output devices 212 as described herein. The entertainment software engine controller 202 communicates with the user input devices to detect player interactions with the controlled entity hybrid gaming system and commands and controls the user output devices to provide a user interface to one or more players of the controlled entity hybrid gaming system as described herein. The game world engine controller 204 communicates using a credit processing subcontroller to one or more player credit processing devices, such as credit input device 210 and credit output device 212 to transfer credits into and out of the controlled entity hybrid gaming system as described herein.

In various embodiments, the game world engine controller 204 uses a credit processing subcontroller operatively connected to one or more credit input devices 210 for generating incoming credit data from a credit input as described herein.

In various embodiments, the credit processing subcontroller is operatively connected to the one or more credit output devices 212 for generating a credit output based on outgoing credit data communicated from the game world engine controller 204 as described herein.

In some embodiments, the credit processing subcontroller is operatively connected to, and communicates with, a TITO system (not shown) or the like to determine incoming credit data representing amounts of credits to be transferred into the controlled entity hybrid gaming system 200 and to generate outgoing credit data representing amounts of credits to be transferred out of the controlled entity hybrid gaming system 200 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the game world engine controller 204 is operatively connected to a central determination controller (not shown) as described herein.

In various embodiments, the game world engine controller 204 may be operatively connected to a progressive controller along (not shown) with one or more other game world engine controllers of one or more other controlled entity hybrid gaming systems as described herein.

FIG. 3B is a diagram of multiplayer or multiplayer electronic gaming machine configuration of a controlled entity hybrid gaming system in accordance with various embodiments of the invention. Types of a multiplayer or multiplayer electronic gaming machine configuration a controlled entity hybrid gaming system include, but are not limited to, multiplayer or multiplayer electronic gaming machines, multiplayer or multiplayer slot machines, multiplayer or multiplayer table gaming devices, multiplayer or multiplayer video arcade consoles and the like. A multiplayer or multiplayer electronic gaming machine configuration of a controlled entity hybrid gaming system 220 includes an entertainment software engine controller 222 as described herein and a game world engine controller 224 as described herein contained in an enclosure such as a housing, cabinet, casing or the like. The enclosure may further include one or more player accessible openings or surfaces that may be used to mount one or more player accessible user input devices and user output devices 228 as described herein, one or more player accessible credit input devices 230 as described herein and one or more player accessible credit output devices 232 as described herein.

In some embodiments, two or more sets of credit input devices and credit output devices are provided so that each player of the multiplayer or multiplayer electronic gaming machine configuration of a controlled entity hybrid gaming system 220 can have an associated set of credit input devices and credit output devices.

The entertainment software engine controller 222 communicates with the user input devices to detect player interactions with the controlled entity hybrid gaming system and commands and controls the user output devices to provide a user interface to one or more players of the controlled entity hybrid gaming system as described herein. The game world engine controller 224 communicates with the credit processing subcontroller 226 or player credit processing devices 230 and 232 to transfer credits into and out of the controlled entity hybrid gaming system as described herein.

In various embodiments, the game world engine controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the game world engine controller 224 as described herein.

In some embodiments, the credit processing subcontroller is operatively connected to, and communicates with, a TITO system (not shown) or the like to determine incoming credit data representing amounts of credits to be transferred into the controlled entity hybrid gaming system 220 and to generate outgoing credit data representing amounts of credits to be transferred out of the controlled entity hybrid gaming system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the game world engine controller 224 is operatively connected to a central determination controller (not shown) as described herein.

In various embodiments, the game world engine controller 224 may be operatively connected to a progressive controller along (not shown) with one or more other game world engine controllers of one or more other controlled entity hybrid gaming systems as described herein.

FIG. 3C is a diagram of virtual reality gaming machine configuration of a controlled entity hybrid gaming system in accordance with various embodiments of the invention. Types of a virtual reality gaming machine configuration of a controlled entity hybrid gaming system include, but are not limited to, virtual reality gaming machines, virtual reality slot machines, virtual reality gaming devices, virtual reality arcade consoles and the like. A virtual reality gaming machine 240 configuration of a controlled entity hybrid gaming system includes an entertainment software engine controller 242, and a game world engine controller 244 contained in an enclosure such as a housing, cabinet, casing or the like. The enclosure may further include one or more player accessible openings or surfaces that may be used to mount one or more player accessible user input devices and user output devices, one or more player accessible credit input devices 246 and one or more player accessible credit output devices 248.

A virtual reality gaming machine configuration 240 of a controlled entity hybrid gaming system further includes a player area 250 having virtual reality sensors for sensing player interactions and/or player movements within the player area, a player headset having a stereoscopic visual display for display of a stereoscopic interactive user interface to a player, headphones for presenting a stereophonic sound presentation to a player, and one or more subwoofers for providing a hepatic or low frequency auditory presentation to the player.

The entertainment software engine controller communicates with the user input devices to detect player interactions with the virtual reality controlled entity hybrid gaming system and commands and controls the user output devices to provide a user interface to one or more players of the virtual reality controlled entity hybrid gaming system as described herein. The game world engine controller communicates with the credit processing subcontroller or player credit processing devices and to transfer credits into and out of the controlled entity hybrid gaming system as described herein.

In many embodiments, the game world engine controller is further connected to one or more side betting terminals that enable spectators of a player using the virtual reality controlled entity hybrid gaming system to make side bets based on the performance of the player.

In various embodiments, the game world engine controller uses a credit processing subcontroller operatively connected to one or more credit input devices for generating incoming credit data from a credit input as described herein.

In various embodiments, the credit processing subcontroller is operatively connected to the one or more credit output devices for generating a credit output based on outgoing credit data communicated from the game world engine controller as described herein.

In some embodiments, the credit processing subcontroller is operatively connected to, and communicates with, a TITO system (not shown) or the like to determine incoming credit data representing amounts of credits to be transferred into the controlled entity hybrid gaming system 240 and to generate outgoing credit data representing amounts of credits to be transferred out of the controlled entity hybrid gaming system 240 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the game world engine controller is operatively connected to a central determination controller (not shown) as described herein.

In various embodiments, the game world engine controller may be operatively connected to a progressive controller along (not shown) with one or more other game world engine controllers of one or more other controlled entity hybrid gaming systems as described herein.

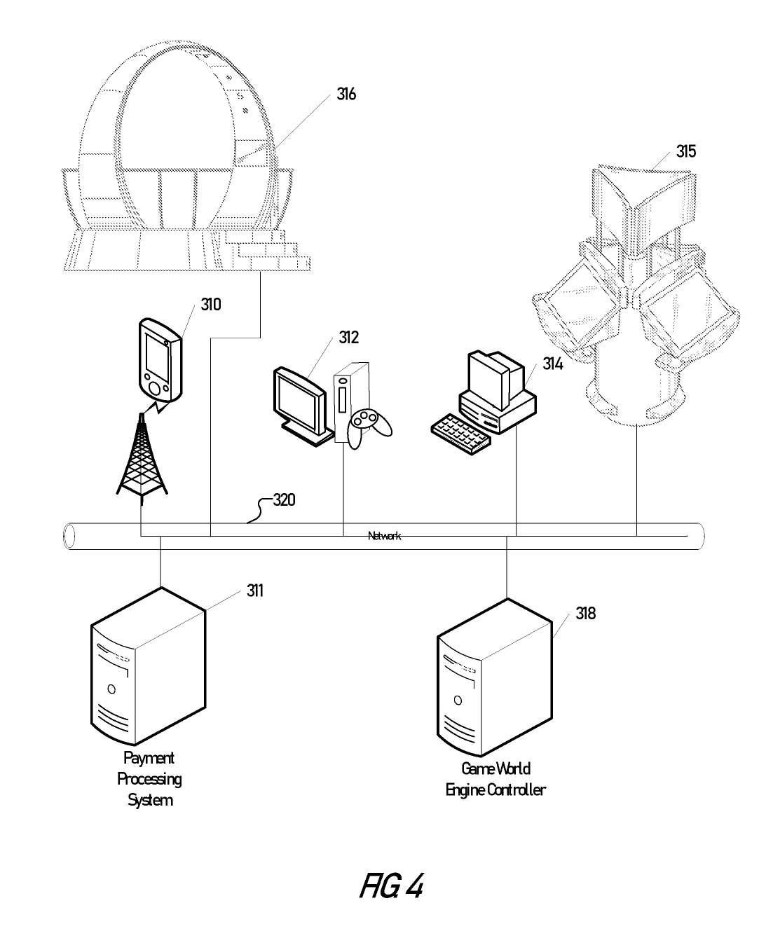

FIG. 4 is a diagram of distributed controlled entity hybrid gaming systems in accordance with various embodiments of the invention. An entertainment software engine controller in a distributed controlled entity hybrid gaming system may be constructed from or configured using any processing device having sufficient processing and communication capabilities to perform the processes of an entertainment software engine controller in accordance with various embodiments of the invention. In some embodiments, the construction or configuration of the entertainment software engine controller may be achieved through the use of an entertainment game control interface and/or through the use of an entertainment game.

In various embodiments, an entertainment game may require extensive processing resources from an entertainment software engine controller leaving few processing resources for the functions performed by a game world engine controller and/or a real world engine subcontroller. By virtue of the architecture described herein, processing loads may be distributed across multiple devices so that operations of the entertainment software engine controller may be dedicated to the entertainment game and the processes of the game world engine controller and/or real world engine subcontroller are not burdened by the requirements of the entertainment game.

In many embodiments, a controlled entity hybrid gaming system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a controlled entity hybrid gaming system are distributed in close proximity to each other and communicate using a local area network and/or a communication bus. In several embodiments, an entertainment software engine controller and a game world engine controller of a controlled entity hybrid gaming system are in a common location and communicate with an external real world engine subcontroller. In some embodiments, a game world engine controller and a real world engine subcontroller of a controlled entity hybrid gaming system are in a common location and communicate with an external entertainment software engine controller. In many embodiments, an entertainment software engine controller, a game world engine controller, and a real world engine subcontroller of a controlled entity hybrid gaming system are located in a common location. In some embodiments, a session subcontroller is located in a common location with a game world engine controller and/or a real world engine subcontroller.

In various embodiments, these multiple devices can be constructed from or configured using a single device or a plurality of devices so that a controlled entity hybrid gaming system is executed as a system in a virtualized space such as, but not limited to, where a game world engine controller is a large scale centralized server in a cloud networking environment operatively connected to widely distributed entertainment software engine controllers via a wide area network such as the Internet or a local area network. In embodiments, the components of a controlled entity hybrid gaming system may communicate using a networking protocol or other type of device-to-device communications protocol.

In some embodiments, a controlled entity hybrid gaming system is deployed over a local area network or a wide area network in a mobile configuration. A mobile configuration of a controlled entity hybrid gaming system is useful for deployment over wireless communication network, such as a wireless local area network or a wireless telecommunications network. A mobile configuration of a controlled entity hybrid gaming system includes an entertainment software engine controller operatively connected by a wireless network to a game world engine controller and a real world engine subcontroller.

In numerous embodiments, an entertainment game server provides a host for managing head-to-head play operating over a network of entertainment software engine controllers connected to the entertainment game server using a communication link. The entertainment game server provides an environment where players can compete directly with one another and interact with other players.

In some embodiments, an entertainment software engine controller may be constructed from or configured using an electronic gaming machine 315, such as a slot machine or the like. The electronic gaming machine 315 may be physically located in various types of gaming establishments.

In many embodiments, an entertainment software engine controller may be constructed from or configured using a portable device 310. The portable device 310 is a device that may wirelessly connect to a network. Examples of portable devices include, but are not limited to, a tablet computer, a personal digital assistant, and a smartphone.

Some controlled entity hybrid gaming systems in accordance with many embodiments of the invention can be distributed across a plurality of devices in various configurations. One or more entertainment software engine controllers of a distributed controlled entity hybrid gaming system, such as but not limited to, a mobile or wireless device 310, a gaming console 312, a personal computer 314, an electronic gaming machine 315, and a virtual reality gaming machine 316 are operatively connected with a game world engine controller 318 of a distributed controlled entity hybrid gaming system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an entertainment software engine controller and a game world engine controller as described herein are executed on the individual entertainment software engine controllers 310, 312, 314, 315 and 316 while one or more processes of a game world engine controller as described herein can be executed by the game world engine controller 318.

In many embodiments, a distributed controlled entity hybrid gaming system and may be operatively connected using a communication link to a session controller (not shown), that performs the processes of a session controller as described herein.

In several embodiments, a distributed controlled entity hybrid gaming system and may be operatively connected using a communication link to credit processing system 311, that performs the processes of one or more credit processing systems as described herein.

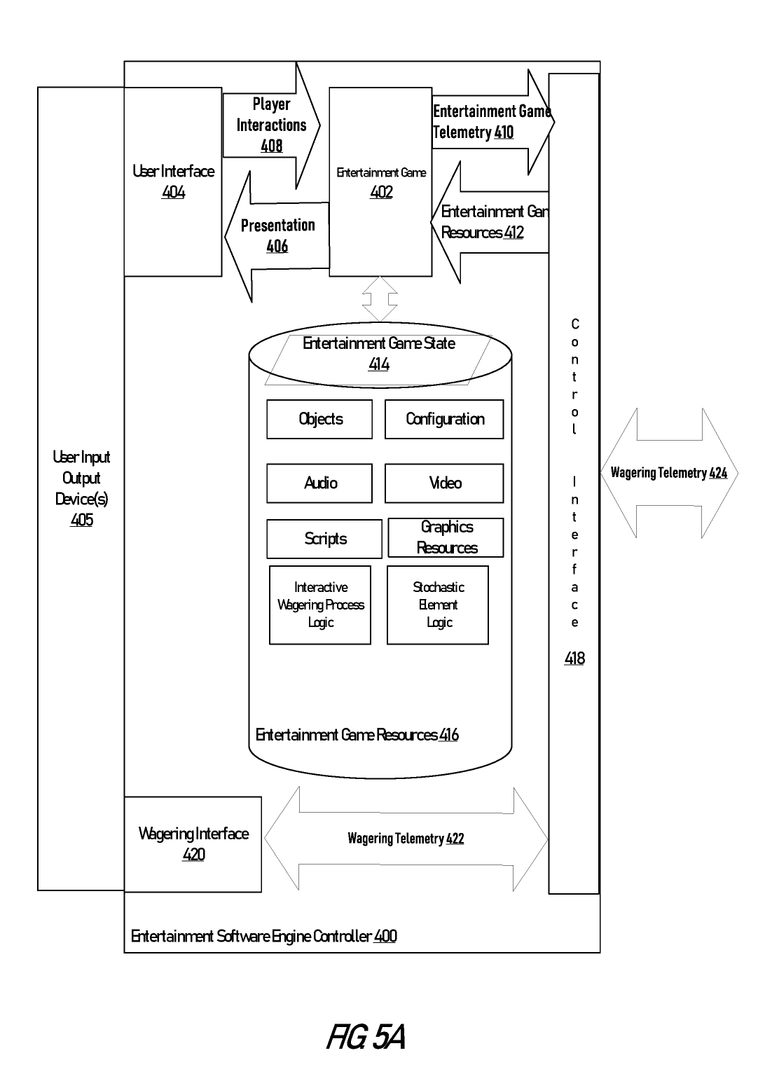

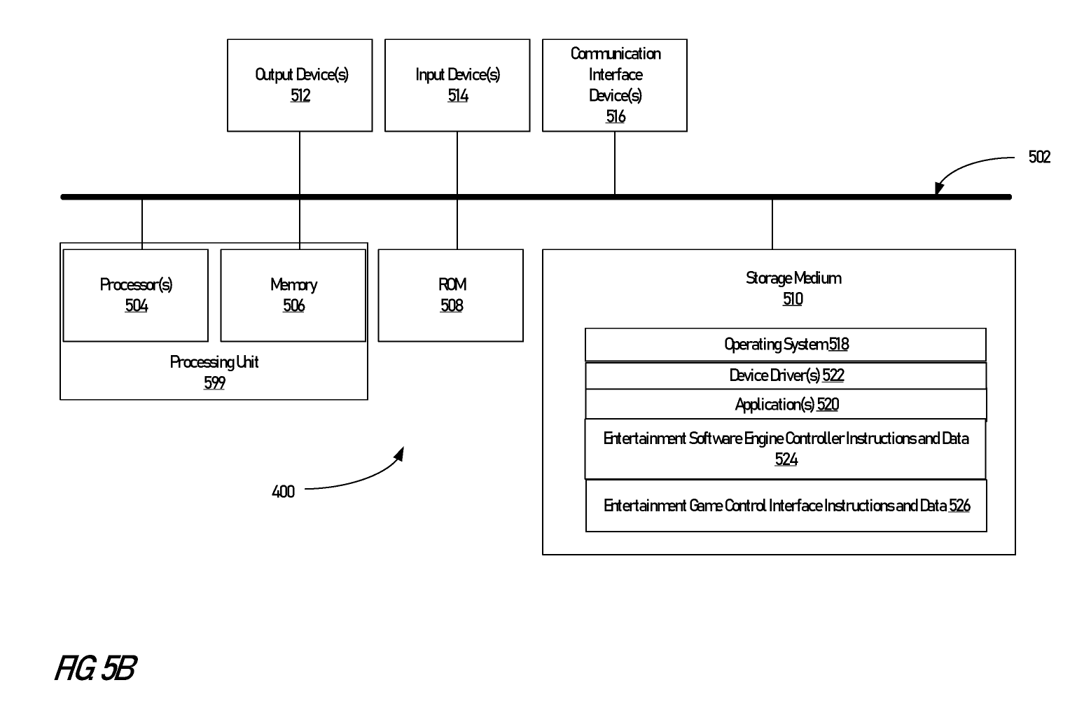

FIGS. 5A and 5B are architecture diagrams of an entertainment software engine controller in accordance with various embodiments of the invention. Referring now to FIG. 5A, an entertainment software engine controller 400 provides an execution environment for an entertainment game 402 of a controlled entity hybrid gaming system. In several embodiments, an entertainment software engine controller 400 of a controlled entity hybrid gaming system provides an entertainment game 402 that generates an entertainment game interface 404 for interaction with by one or more players. The entertainment game 402 generates an interactive user interface 406 that is presented to the player through the entertainment game interface 404 using one or more user input and output devices 405. The interactive user interface 406 may include audio features, visual features or tactile features, or any combination of these features. In various embodiments, the entertainment game interface 404 utilizes one or more user interface input and output devices 405 so that a player can interact with the interactive user interface 406. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the entertainment game 402 in entertainment game telemetry data 410 that is communicated by entertainment software engine controller 400 as part of hybrid gaming wagering telemetry data 424 to various other components of a controlled entity hybrid gaming system as described herein. The entertainment game 402 receives entertainment game resources 412 communicated as part of hybrid gaming wagering telemetry data 424 from various other components of a controlled entity hybrid gaming system as described herein. In some embodiments, the hybrid gaming wagering telemetry data 424 may include player interactions with objects of the entertainment game and an award state of a hybrid gaming wagering process presented to the player by the entertainment game 402.

In some embodiments, various components of the entertainment game 402 can read data from an entertainment game state 414 in order to provide one or more features of the entertainment game. In various embodiments, components of the entertainment game 402 can include, but are not limited to: a physics engine; a rules engine; an audio engine; a graphics engine and the like. The physics engine is used to simulate physical interactions between interactive elements in the entertainment game 402. The rules engine implements the rules of the entertainment game and a random number generator that may be used for influencing or determining certain variables and/or outcomes to provide a randomizing influence on the operations of the entertainment game. The graphics engine is used to generate a visual representation of the entertainment game state to the player. The audio engine is used to generate an audio representation of the entertainment game state to the player.

During operation, the entertainment game reads and writes entertainment game resources 416 stored on a data store of the entertainment software engine controller 400. The entertainment game resources 416 may include objects having graphics and/or control logic used to provide interactive elements of the entertainment game. In various embodiments, the resources may also include, but are not limited to, video files that are used to generate a portion of the interactive user interface 406; audio files used to generate music, sound effects, etc. within the entertainment game; configuration files used to configure the features of the entertainment game; scripts or other types of control code used to provide various features of the entertainment game; graphics resources such as textures, objects, etc. that are used by a graphics engine to render objects displayed in an entertainment game; hybrid gaming wagering process logic used to determine an award state of a hybrid gaming wagering process using player interactions with the interactive user interface; and gambling game logic used by the entertainment game to generate one or more gambling game outcomes used as entertainment game resources.

In operation, components of the entertainment game 402 read portions of the entertainment game state 414 and generate the interactive user interface 406 for the player that is presented to the player using the user interface 404. The player perceives the interactive user interface and provides player interactions 408 using the user input devices. The corresponding player interactions are detected as player actions or inputs by various components of the entertainment game 402. The entertainment game 402 translates the player actions into interactions with the interactive elements of the entertainment game. Components of the entertainment game use the player interactions with the interactive elements of the entertainment game and the entertainment game state 414 to update the entertainment game state 414 and update the interactive user interface 406 presented to the player. The process loops continuously while the player interacts with the entertainment game of the controlled entity hybrid gaming system.

The entertainment software engine controller 400 provides one or more interfaces 418 between the entertainment software engine controller 400 and other components of a controlled entity hybrid gaming system, such as, but not limited to, a game world engine controller. The entertainment software engine controller 400 and the other controlled entity hybrid gaming system components communicate with each other using the interface. The interface may be used to pass various types of data, and to communicate and receive messages, status data, commands and the like. In certain embodiments, the entertainment software engine controller 400 and a game world engine controller communicate wagering telemetry data 424. In some embodiments, the communications include requests by the game world engine controller that the entertainment software engine controller 400 update the entertainment game state 414 using data provided by the game world engine controller.

In many embodiments, communications between a game world engine controller and the entertainment software engine controller 400 includes a request that the entertainment software engine controller 400 update one or more resources 416 using data provided by the game world engine controller. In a number of embodiments, the entertainment software engine controller 400 provides all or a portion of the entertainment game state to the game world engine controller. In some embodiments, the entertainment software engine controller 400 may also provide data about one or more of the entertainment game resources 416 to the game world engine controller. In some embodiments, the communication includes player interactions that the entertainment software engine controller 400 communicates to the game world engine controller. The player interactions may be low level player interactions with the user interface 404, such as manipulation of an input device, or may be high level player interactions with game world objects as detected by the entertainment game. The player interactions may also include resultant actions such as modifications to the entertainment game state 414 or game resources 416 resulting from the player's interactions taken in the controlled entity hybrid gaming system entertainment game. In some embodiments, player interactions include, but are not limited to, actions taken by entities such as non-player characters (NPCs) of the entertainment game that act on behalf of or under the control of the player.

In various embodiments, the entertainment game resources 412 include entertainment game resources used by the entertainment game 402 to generate an interactive user interface of a hybrid gaming wagering process presented to a player and to determine intermediate states based on the player's skillful interaction with the interactive user interface. In many embodiments, data of the entertainment game resources 412 includes data of one or more gambling game outcomes as described herein.

In some embodiments, the entertainment software engine controller 400 includes a gambling game user interface 420 used to provide and receive wagering telemetry data 422 to and from the player. The controlled entity hybrid gaming system telemetry data 422 from the controlled entity hybrid gaming system includes, but is not limited to, data used by the player to configure a wager, data used to communicate as part of hybrid gaming wagering telemetry data 424 a state of a hybrid gaming wagering process, and data about a wagering outcome.

In some embodiments, the entertainment software engine controller includes one or more sensors (not shown). Such sensors may include, but are not limited to, physiological sensors that monitor the physiology of the player, environmental sensors that monitor the physical environment of the entertainment software engine controller, accelerometers that monitor changes in motion of the entertainment software engine controller, and location sensors that monitor the location of the entertainment software engine controller such as global positioning sensors (GPSs). The entertainment software engine controller 400 communicates sensor telemetry data to one or more components of the controlled entity hybrid gaming system.

Referring now to FIG. 5B, entertainment software engine controller 400 includes a bus 502 that provides an interface for one or more processors 504, random access memory (RAM) 506, read only memory (ROM) 508, machine-readable storage medium 510, one or more user output devices 512 as described herein, one or more user input devices 514 as described herein, and one or more communication interface devices 516 for implementing one or more interfaces as described herein.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an entertainment software engine controller processing unit 599. In some embodiments, the entertainment software engine controller processing unit includes one or more processors operatively connected to one or more of a RAM, ROM, and machine-readable storage medium; the one or more processors of the entertainment software engine controller processing unit receive instructions stored by the one or more of a RAM, ROM, and machine-readable storage medium via a bus; and the one or more processors execute the received instructions. In some embodiments, the entertainment software engine controller processing unit is an ASIC (Application-Specific Integrated Circuit). In some embodiments, the entertainment software engine controller processing unit is a SoC (System-on-Chip).

The one or more communication interface devices 516 provide one or more wired or wireless interfaces for communicating data and commands between the entertainment software engine controller 400 and other devices that may be included in a controlled entity hybrid gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the entertainment software engine controller, such as but not limited to: an operating system 518; one or more device drivers 522; one or more application programs 520 including but not limited to an entertainment game; and controlled entity hybrid gaming system entertainment software engine controller instructions and data 524 for use by the one or more processors 504 to provide the features of an entertainment software engine controller as described herein. In some embodiments, the machine-executable instructions further include entertainment game control interface/entertainment game control interface instructions and data 526 for use by the one or more processors 504 to provide the features of an entertainment game control interface/entertainment game control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the entertainment software engine controller 400 to provide the features of a controlled entity hybrid gaming system entertainment software engine controller as described herein

Although the entertainment software engine controller is described herein as being constructed from or configured using one or more processors and instructions stored and executed by hardware components, the entertainment software engine controller can be constructed from or configured using only hardware components in accordance with other embodiments. In addition, although the storage medium 510 is described as being operatively connected to the one or more processors through a bus, those skilled in the art of entertainment software engine controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the entertainment software engine controller 400 can be distributed across a plurality of different devices. In many embodiments, an entertainment software engine controller of a controlled entity hybrid gaming system includes an entertainment game server operatively connected to an interactive client using a communication link. The entertainment game server and entertainment game client cooperate to provide the features of an entertainment software engine controller as described herein.

In various embodiments, the entertainment software engine controller 400 may be used to construct other components of a controlled entity hybrid gaming system as described herein.

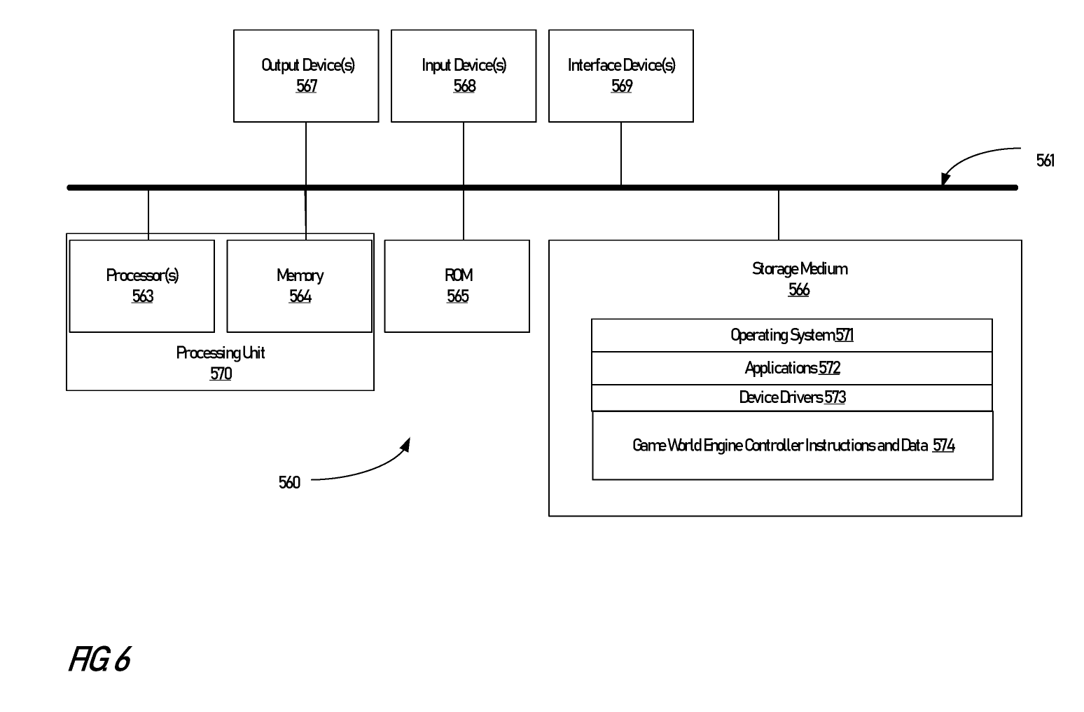

FIG. 6 is an architecture diagram of a game world engine controller, suitable for use as game world engine controller 104 of FIG. 2, of a controlled entity hybrid gaming system in accordance with various embodiments of the invention. A game world engine controller may be constructed from or configured using one or more processing devices that perform the operations of the game world engine controller. In many embodiments, a game world engine controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Game world controller 560 includes a bus 561 providing an interface for one or more processors 563, random access memory (RAM) 564, read only memory (ROM) 565, machine-readable storage medium 566, one or more user output devices 567 as described herein, one or more user input devices 568 as described herein, and one or more communication interface and/or network interface devices 569 used to implement one or more interfaces as described herein.

The one or more processors 563 may take many forms, such as, but not limited to: a central processing unit (CPU); a multi-processor unit (MPU); an ARM processor; a programmable logic device; or the like.

In the example embodiment, the one or more processors 563 and the random access memory (RAM) 564 form a game world engine controller processing unit 570. In some embodiments, the game world engine controller processing unit includes one or more processors operatively connected to one or more of a RAM, ROM, and machine-readable storage medium; the one or more processors of the game world engine controller processing unit receive instructions stored by the one or more of a RAM, ROM, and machine-readable storage medium via a bus; and the one or more processors execute the received instructions. In some embodiments, the game world engine controller processing unit is an ASIC (Application-Specific Integrated Circuit). In some embodiments, the game world engine controller processing unit is a SoC (System-on-Chip).

The one or more communication interface and/or network interface devices 569 provide one or more wired or wireless interfaces for exchanging data and commands between the game world engine controller 560 and other devices that may be included in a controlled entity hybrid gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 566 stores machine-executable instructions for various components of the game world engine controller 560 such as, but not limited to: an operating system 571; one or more applications 572; one or more device drivers 573; and controlled entity hybrid gaming system game world engine controller instructions and data 574 for use by the one or more processors 563 to provide the features of a game world engine controller as described herein.

In various embodiments, the machine-readable storage medium 566 is one of a (or a combination of two or more of) a hard drive, a flash drive, a DVD, a CD, a flash storage, a solid state drive, a ROM, an EIEPROM, and the like.

In operation, the machine-executable instructions are loaded into memory 564 from the machine-readable storage medium 566, the ROM 565 or any other storage location. The respective machine-executable instructions are accessed by the one or more processors 563 via the bus 561, and then executed by the one or more processors 563. Data used by the one or more processors 563 are also stored in memory 564, and the one or more processors 563 access such data during execution of the machine-executable instructions. Execution of the machine-executable instructions causes the one or more processors 563 to control the game world engine controller 560 to provide the features of a controlled entity hybrid gaming system game world engine controller as described herein.

Although the game world engine controller 560 is described herein as being constructed from or configured using one or more processors and instructions stored and executed by hardware components, the game world engine controller can be composed of only hardware components in accordance with other embodiments. In addition, although the storage medium 566 is described as being operatively connected to the one or more processors through a bus, those skilled in the art of game world engine controllers will understand that the storage medium can include removable media such as, but not limited to, a USB memory device, an optical CD ROM, magnetic media such as tape and disks. Also, in some embodiments, the storage medium 566 may be accessed by processor 563 through one of the interfaces or using a communication link. Furthermore, any of the user input devices or user output devices may be operatively connected to the one or more processors 563 via one of the interfaces or using a communication link.

In various embodiments, the game world engine controller 560 may be used to construct other components of a controlled entity hybrid gaming system as described herein.

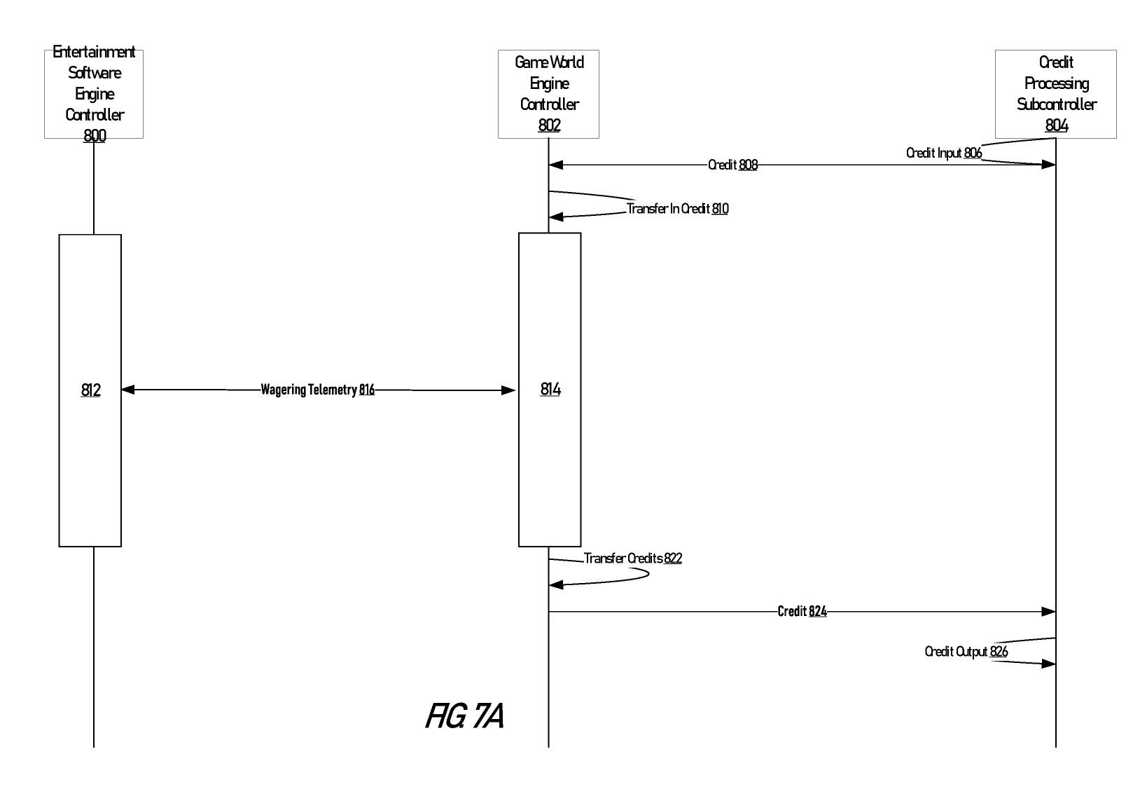

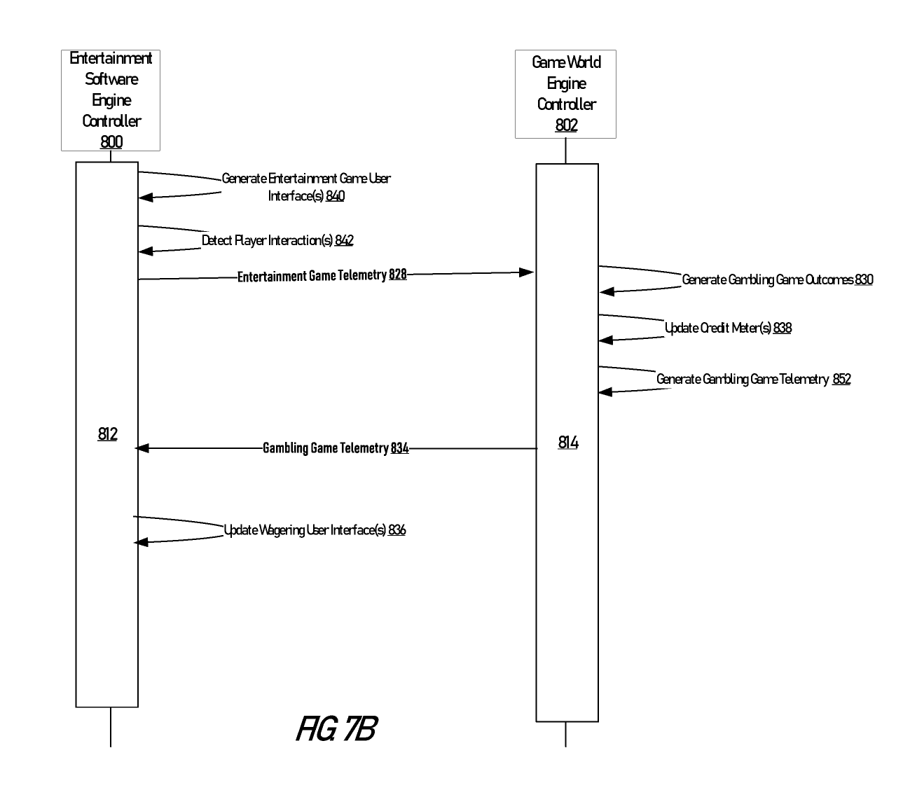

Referring now to FIG. 7A, in some embodiments, at a beginning of the wagering session, the process includes a credit input 806 to the controlled entity hybrid gaming system with a game world engine controller 802 communicating with a credit processing subcontroller 804 to receive incoming credit data 808. The game world engine controller 802 uses the incoming credit data to transfer 810 credits onto one or more player credit meters associated with one or more players of the controlled entity hybrid gaming system, thus transferring credits into the controlled entity hybrid gaming system and on to the one or more player credit meters.

During the hybrid gaming wagering process 812 and 814, an entertainment software engine controller 800 and the game world engine controller 802 communicate hybrid gaming wagering telemetry data 816 used by the controllers to implement the hybrid gaming wagering process. The data communicated includes data of, but is not limited to, entertainment game telemetry, entertainment game resources, wagering telemetry, intermediate states, and/or award states of the hybrid gaming wagering process as described herein.

In many embodiments, upon determining that a wagering session is completed, such as by receiving a cashout communication from the one or more players of the controlled entity hybrid gaming system, the game world engine controller 802 transfers 822 credits off of the one or more player credit meters, generates outgoing credit data 824 on the basis of the credits transferred off of the one or more player credit meters, and communicates the outgoing credit data 824 to the credit processing subcontroller 804. The credit processing subcontroller 804 receives the outgoing credit data 824 and generates 826 a credit output as described herein, thus transferring credits off of the one or more player credit meters and out of the controlled entity hybrid gaming system.

Referring now to FIG. 7B, in slightly more detail, the entertainment software engine controller 800 generates 840 an interactive entertainment game user interface and detects 842 one or more player interactions of the one or more players with interactive elements of the interactive user interface.

The entertainment software engine controller 800 communicates entertainment game telemetry data 828 to the game world engine controller 802. The interactive hybrid gaming wagering telemetry data 828 includes, but is not limited to, data of one or more player interactions detected by the entertainment software engine controller 800 and/or one or more entertainment game events.

The game world engine controller 802 receives the entertainment game telemetry data 828. Upon determination by the game world engine controller 802 that the entertainment game telemetry data indicates a gambling game outcome of the hybrid gaming wagering process is to be generated in accordance with a state of the hybrid gaming wagering process, the game world engine controller 802 generates 830 one or more gambling game outcomes. In the case that one or more of the gambling game outcomes is generated in association with a commitment of an amount of credits to a wager, the game world engine controller 802 updates 838 one or more credit meters to reflect the wager commitment. The game world engine controller 802 generates 852 gambling game telemetry data 834 including one or more gambling game outcomes and communicates the gambling game telemetry data 834 to the entertainment software engine controller 800.

The entertainment software engine controller 800 receives the gambling game telemetry data 834 from the game world engine controller 802 and uses the gambling game telemetry data to update 836 an interactive gambling game user interface of the entertainment software engine controller.

In some embodiments, at a beginning of the wagering session, the process includes a GWC input to the controlled entity hybrid gaming system with the game world engine controller 802 communicating with the credit processing subcontroller 803 to receive incoming GWC data. The game world engine controller 802 uses the incoming GWC data to transfer GWC onto one or more GWC meters associated with one or more players of the controlled entity hybrid gaming system, thus transferring GWC into the controlled entity hybrid gaming system and on to the one or more GWC meters. The game world engine controller 802 uses interactive intermediate state data of an entertainment game to generate an amount of GWC to award to a player based on the player's achievement of one or more objectives of the entertainment game. Upon determining that the wagering session is completed, such as by receiving a cashout communication from one or more players of the controlled entity hybrid gaming system, the game world engine controller 802 transfers GWC off of the one or more GWC meters, generates outgoing GWC data on the basis of the GWC transferred off of the one or more GWC meters, and communicates the outgoing GWC data to the credit processing subcontroller 803. The credit processing subcontroller receives the outgoing GWC data and generates an GWC output as described herein, thus transferring GWC off of the one or more GWC meters and out of the controlled entity hybrid gaming system.

Among factors in the functioning of a controlled entity hybrid game are one or more enabling elements (EE), one or more actionable elements (AE), one or more controlled entities (CE) and their interoperability with the game.

EEs for a controlled entity hybrid game include types of consumable commodities and/or accumulating elements in a game context utilized to play and operate characters or take actions in a game space. Types of EE include (but are not limited to): weapons ammunition, health points in a fighting game, potions in the case of a fantasy game, fuel in the case of a driving game, time in the case of a game where one races against the clock to achieve some objective, armies in the case of a military strategy game, or downs in the case of football. The nature of EE is a function of the type of entertainment game executed on the entertainment software engine controller and its structure. In some embodiments, the consumption of EE in the process of playing the entertainment software engine controller entertainment game would trigger gambling plays on the real world engine subcontroller portion of the controlled entity hybrid game. In various embodiments, it is also possible that the events of or acts of accumulation of EE in the entertainment game might also trigger real world engine subcontroller gambling plays in the same manner that consumption of EE would. Additionally, in some embodiments, it is possible that EE is recycled. The recycling or reuse of EE might also trigger real world engine subcontroller gambling plays. This is to say that games could use either EE consumption, EE accumulation, EE recycling or a combination of events to trigger real world engine subcontroller wagers. The correlation of what events resulting in the accumulation or consumption of EE might trigger real world engine subcontroller plays, and when, and the amount of RC wagered as a result of these events, would be a function of algorithms and formulae operating within the game world engine controller and the controlled entity hybrid game. It should be understood that as consistent with controlled entity hybrid game methods that other triggers for real world engine subcontroller plays other than EE consumption or accumulation could be possible.

Like EE, an AE can initiate a gambling game by committing RC to the gambling proposition within the real world engine subcontroller. Like an EE, AE may be consumed, recycled or accumulated. AEs, are tied to specific player decisions or player directed actions that are undertaken in the context of the entertainment game, the outcome of those decisions or actions, or a game event or milestone points, or the transpiring of real or virtual game time in the process of playing the entertainment game. AEs, are constructs within the entertainment game affected by player world decisions or actions subject to various formulae and algorithms as to whether the player world action or decision causes the AE to transpire.

A controlled entity (CE) includes, but is not limited to, a player's game world character, an entity, an inanimate object, a device or other object under control of the player.

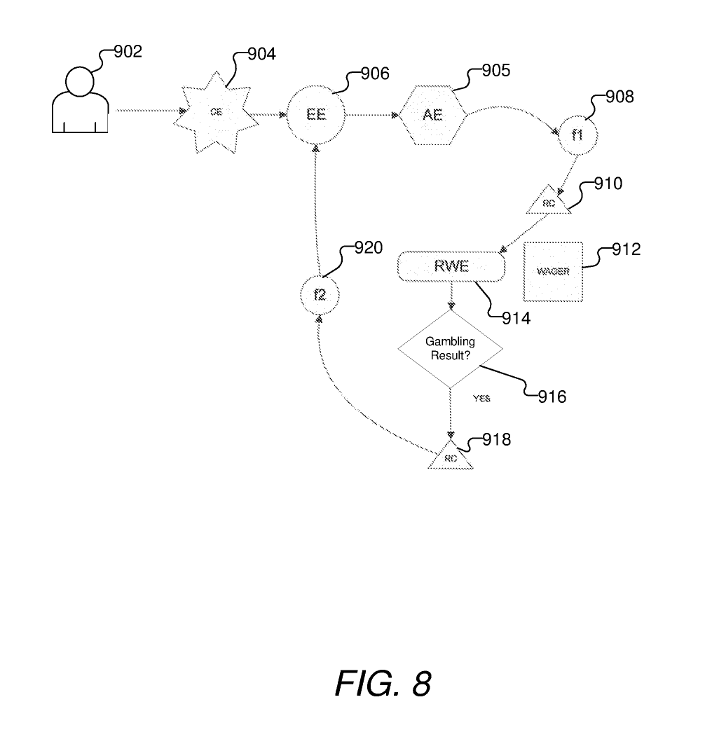

FIG. 8 is a flow chart illustrating use of a controlled entity in accordance with an embodiment of the invention. In FIG. 8, a player uses an entertainment game user interface to instruct 902 a controlled entity 904 as part of gameplay of the entertainment game of a hybrid game. The controlled entity 904 consumes an entertainment game element, such as EE 906. This in turn causes an AE 905 to take place, which in turn triggers a wager 912 in a real world engine subcontroller 914. The gambling game outcome 916 is displayed to the player in a gambling game user interface and creates as an output a change in the amount of RC 918 and a change in the amount of the EE 906. The amount of RC 910 committed to the wager is a function (f1) 908 of the AE 905 in this case, and the result of the wager, if positive, generates RC 918. The gambling game outcome also, by function f2 920, determines a further change in an attribute in EE 906. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented on a negative gambling game outcome. In still further embodiments, a character, attribute or type of EE may be changed. The change in EE is displayed to the player in the entertainment game user interface.

In a particular embodiment, a controlled entity hybrid game implements a racing game. In such a game, gasoline is treated as an EE and is consumed in a car, which is an example of a CE, that is driven around a track by a player. Upon passing a starting line (i.e. completing one lap), an AE occurs (i.e. the negotiation of one lap), which causes an amount of RC to be committed to a gambling game as a function of f1 (a relationship between AE and RC). If the gambling game has a positive outcome and returns RC, the CE (in this case the car) also realizes an increase in gasoline (EE) as a function of function f2. The player instructs the CE in this embodiment by turning a steering wheel, and depressing brake and accelerator pedals.

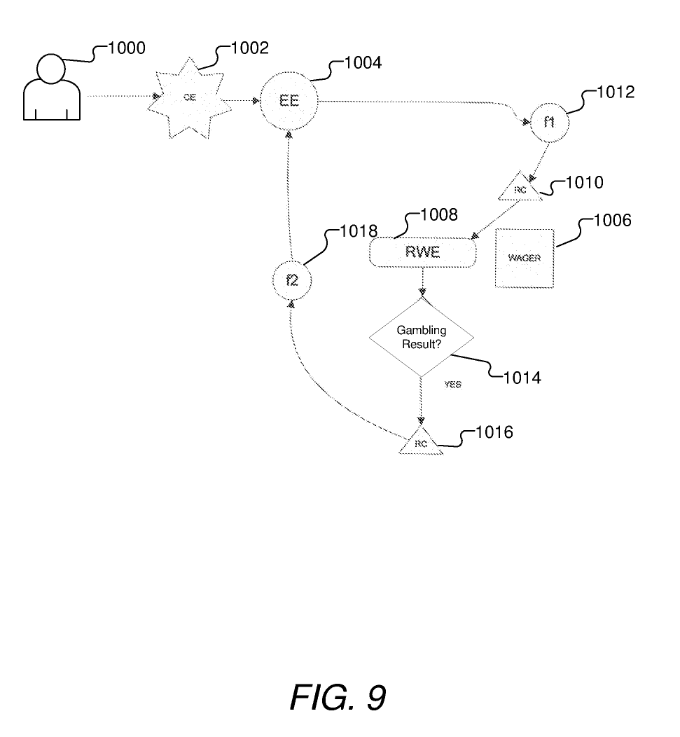

FIG. 9 is a flow chart illustrating another use of a controlled entity in accordance with an embodiment of the invention. In FIG. 9, a player 1000 using an entertainment game user interface instructs a controlled entity 1002 and the controlled entity consumes an EE 1004, which in turn triggers a wager 1006 in the real world engine subcontroller 1008. A gambling game outcome 1014 of the wager then creates as output a change in an amount of RC 1016 that is displayed to the player in a gambling game user interface and a change in an amount of EE 1004. The amount of RC 1010 committed to the wager is a function (f1) 1012 of EE 1004 in this case, and the result 1014 of the wager 1006, if positive, generates RC 1016. The gambling game outcome is displayed to the player using a gambling game user interface. The gambling game outcome also, by function (f2) 1018, determines a further change in an attribute of EE 1004. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface.

In a specific embodiment, a racing game is implemented using a controlled entity hybrid game. Gasoline (EE) is consumed as the car (Controlled Entity—CE) is driven around the track. Upon consumption of a discrete amount of EE, an amount of RC to be committed to the game as a function of f1 (a relationship between EE and RC). If the gambling game has a positive outcome and returns RC, the controlled entity (in this case the car) also realizes an increase in gasoline (EE) as a function of function f2. The player instructs the CE in this example by turning a steering wheel, and depressing brake and accelerator pedals.

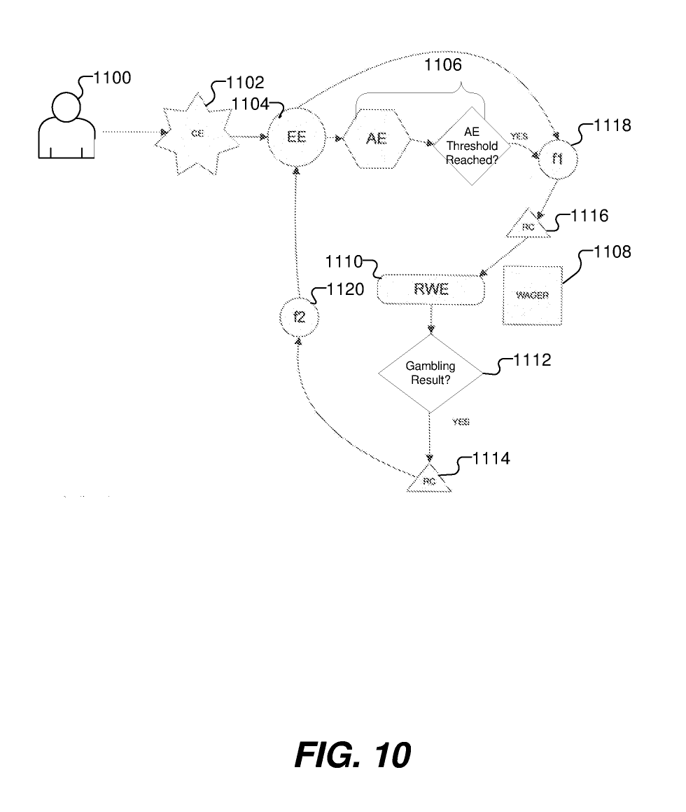

FIG. 10 is a flow chart illustrating another use of a controlled entity in accordance with an embodiment of the invention. In FIG. 10, using an entertainment game user interface, a player 1100 instructs a controlled entity 1102 of the entertainment game which in turn consumes an EE 1104. This in turn causes an AE 1106 to take place, which in turn triggers a wager 1108 in an real world engine subcontroller 1110. A gambling game outcome 1112 then creates as output a change 1114 in the amount of RC that is displayed to the player using a gambling game interface and a change in the amount of EE 1104 that is displayed to the player in the entertainment game user interface. An amount of RC 1116 committed to the wager is a function (f1) 1118 of EE 1104 and not AE 1106 in this case, and the result of the wager, if positive, generates RC. The gambling game outcome also, by function f2 1120, determines a further change in an attribute of EE 1104. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface.

In one embodiment, a racing game is implemented using a controlled entity hybrid game. Gasoline (EE) is consumed as the car (Controlled Entity—CE) is driven around the track. Upon driving 1 km an AE occurs, which causes an amount of RC to be committed to the game as a function of f1 (a relationship between EE and RC). If the gambling game has a positive outcome and returns RC, the controlled entity (in this case the car) also realizes an increase in gasoline (EE) as a function of function f2. The player instructs the CE in this example by turning a steering wheel, and depressing brake and accelerator pedals. What is interesting about this implementation is that the amount that one has to commit to the gambling game can be a function of skill (i.e. if one consumes more gas to drive 1 kM one may have to commit more or less RC to the gambling game as a function of ‘f1’).

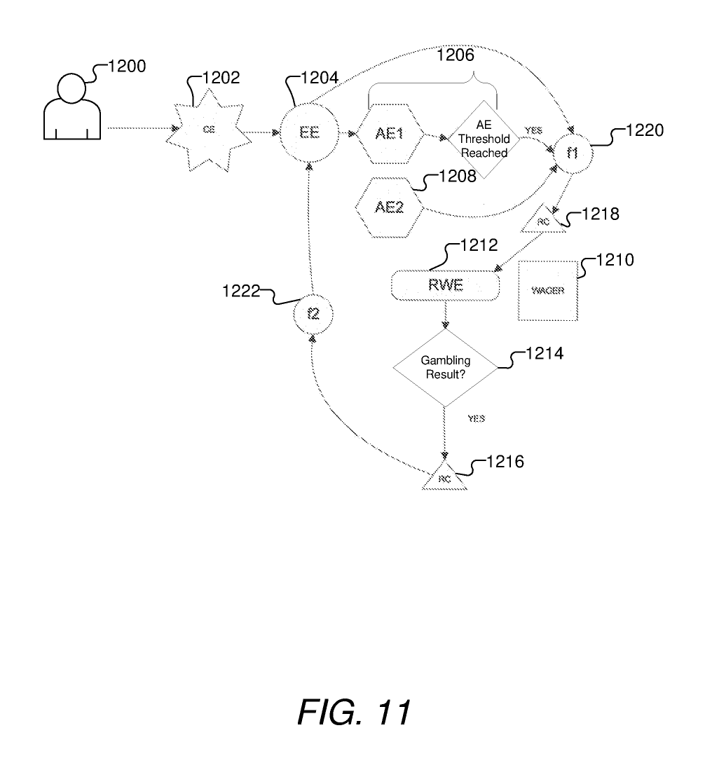

FIG. 11 is a flow chart illustrating another use of a controlled entity in accordance with an embodiment of the invention. In FIG. 11, using an entertainment game user interface, a player 1200 instructs a controlled entity 1202 which in turn consumes an EE 1204. This in turn causes one or more AEs, such as AE1 1206 and AE2 1208, to take place, which in turn triggers a wager 1210 in the real world engine subcontroller 1212. The gambling game outcome 1214 then creates as output a change in the amount of RC 1216 that is displayed to the player in a gambling game user interface and a change in the amount of EE 1204. The amount of RC 1218 committed to the wager is a function (f1) 1220 of EE 1204 and AE2 1208, and the result of the wager, if positive, generates RC 1216. The gambling game outcome also, by function f2 1222, determines a further change in an attribute of EE 1204. There may be one or more (n) AEs, such as AE2 1208 affecting the amount of RC 1218 committed to the wager, where n is greater or equal to 1. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface.

In one embodiment, a racing game is implemented using a controlled entity hybrid game. Gasoline (EE) is consumed as the car (Controlled Entity—CE) is driven around the track. Upon driving 1 km an AE1 occurs, which causes an amount of RC to be committed to the game as a function of f1 (a relationship between EE, AE2 and RC). In this embodiment, AE2 is the number of competitor cars (either computer controlled or operated by competitive players via their CEs) that are passed while achieving AE1. If the gambling game has a positive outcome and returns RC, the controlled entity (in this case the car) also realizes an increase in gasoline (EE) as a function of function f2. The player instructs the CE in this example by turning a steering wheel, and depressing brake and accelerator pedals. What is interesting about this implementation is that the amount that one has to commit to the gambling game can be a function of skill (i.e. if one consumes more gas to drive 1 kM one may have to commit more or less RC to the gambling game as a function of ‘f1’).

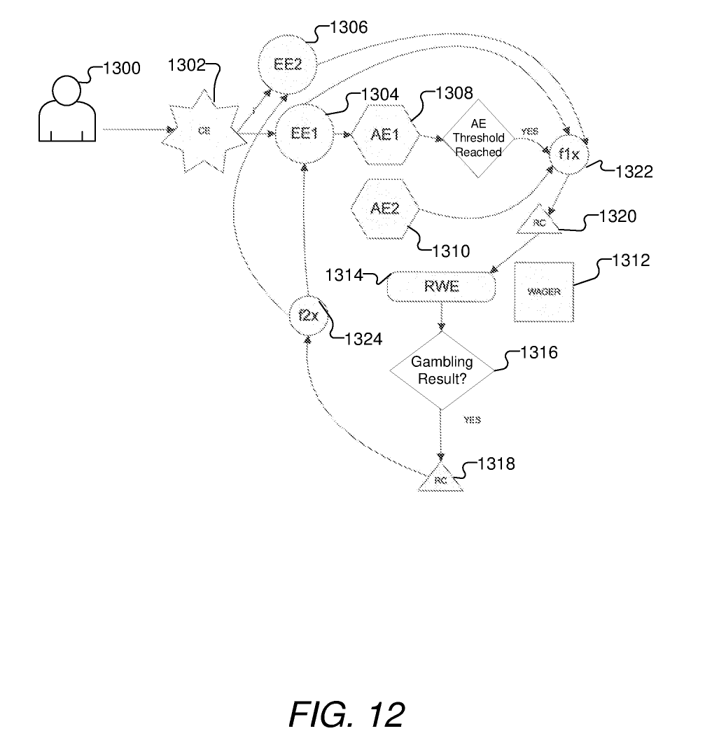

FIG. 12 is a flow chart illustrating another use of a controlled entity in accordance with an embodiment of the invention. In FIG. 12, using an entertainment game user interface, a player 1300 instructs a controlled entity 1302 which in consumes one or a multitude of EE, such as EE1 1304 and EE2 1306. This in turn causes one or more AE to take place, such as AE1 1308 and AE2 1310, which in turn triggers a wager 1312 in an real world engine subcontroller 1314. A gambling game outcome 1316 then creates as output a change in the amount of RC 1318 that is displayed to the player in a gambling game user interface and a change in the amount of one or more EE, such as EE1 1304 and EE2 1306. The amount of RC committed 1320 to the wager is governed by functions (f1x) 1322 taking as arguments one or a multitude each of EE and AE, such as EE2, EE2, AE1 and AE2, and the result of the wager, if positive, generates RC. The gambling game outcome also, by a set of functions f2x 1324, determines a further change of an attribute of one or a multitude of EE, such as EE1 and EE2. There may be n AE (and m EE) affecting the amount of RC committed to the wager, where one of (m and n) is greater than zero and the other of (m and n) is zero or greater than zero. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface.

In one embodiment, a racing game is implemented using a controlled entity hybrid game. An example would be a racing game. Gasoline (EE1) and driver stamina (EE2) is consumed as the car (Controlled Entity—CE) is driven around the track. Upon driving 1 km an AE1 occurs, which causes an amount of RC to be committed to the game as a function of f1x (a set of relationships between EE1, EE2, AE2 and RC). In this example, AE2 is the number of competitor cars (either computer controlled or operated by competitive players via their CEs) that are passed while achieving AE1. If the gambling game has a positive outcome and returns RC, the controlled entity (in this case the car) also realizes an increase in gasoline (EE1) and/or EE2 (driver stamina) as a function of function f2x. The player instructs the CE in this example by turning a steering wheel, and depressing brake and accelerator pedals. What is interesting about this implementation is that the amount that one has to commit to the gambling game can be a function of skill (i.e. if one consumes more gas to drive 1 kM one may have to commit more or less RC to the gambling game as a function of ‘f1x’).

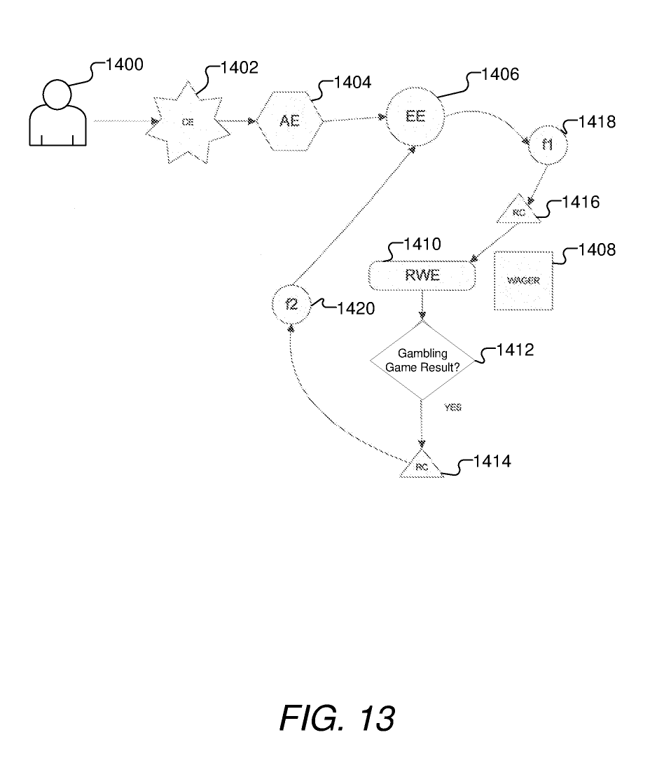

FIG. 13 is a flow chart illustrating another use of a controlled entity in accordance with an embodiment of the invention. In FIG. 13, a player, using an entertainment game user interface, 1400 instructs controlled entity 1402 which in turn undertakes an actionable element (AE) 1404. This in turn causes EE 1406 to be consumed, which in turn triggers a wager 1408 in the real world engine subcontroller 1410. A gambling game outcome 1412 then creates as output a change in the amount of RC 1414 that is displayed to the player in a gambling game user interface and a change in the amount of EE 1406. The amount of RC 1416 committed to the wager is a function (f1) 1418 of EE 1406, and the result of the wager, if positive, generates RC. The gambling game outcome also, by function f2 1420, determines a further change in an attribute of EE 1406. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface.

In one embodiment, an adventure game is implemented in a controlled entity hybrid game. The controlled entity in this case is an adventurer. The adventurer opens a safe (the AE) and in so doing consumes a certain amount of health points (the EE). An amount of RC is committed to the gambling game as a function of the amount of EE consumed. The gambling game returns a specific amount of RC, which if greater than zero generates a change in the adventurer's health points (EE) via function f2. It should be understood that each of the aforementioned elements of certain embodiments (i.e. multiple EE, AE, their combination affecting wagering, the need to undertake a specific AE to launch a wager, etc.) can likewise be applied to the above construct, where the causality between AE and EE has been inverted.

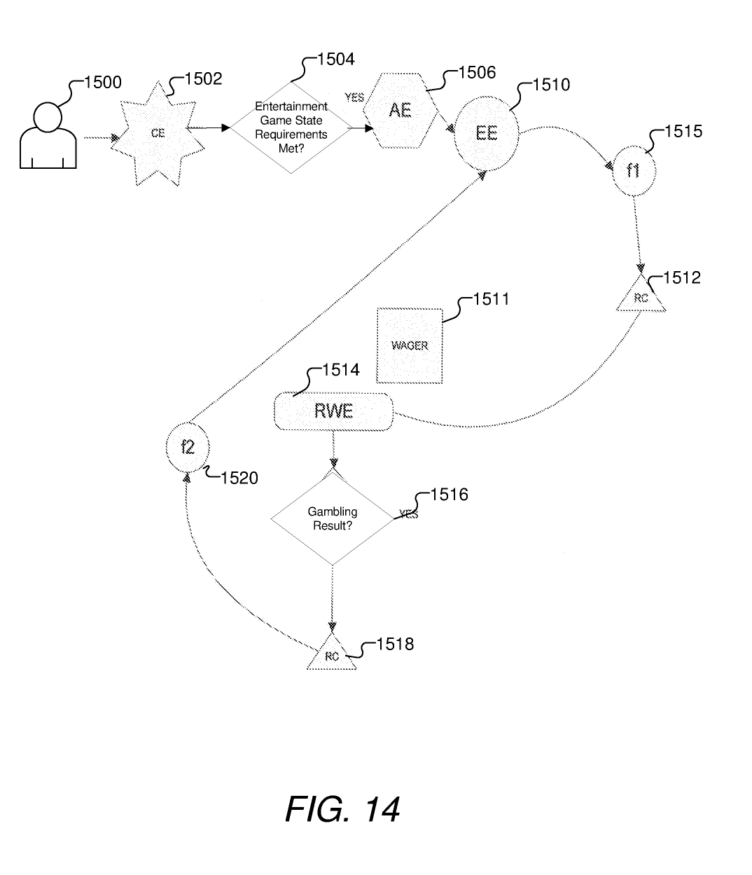

FIG. 14 is a flow chart illustrating another use of a controlled entity in accordance with an embodiment of the invention. In FIG. 14, a player 1500, using an entertainment game user interface, instructs controlled entity 1502 which in turn undertakes an actionable element within the entertainment game. The diamond 1504 represents an area of interest within an entertainment game. Specifically, before a CE can undertake an action certain entertainment game state requirements may be required to be met. This can include, but is not limited to, characteristics or attributes of the CE, possessions of the CE, the state of game play generally, the value of various game objects, etc. In a particular embodiment, in an adventure game, a CE is directed to open a door, as indicated by AE 1506. This would in turn cause the consumption of a certain amount of health points (EE) 1510, which would in turn trigger the commitment as a wager 1511 of RC 1512 to a gambling game within an real world engine subcontroller 1514. The amount of RC committed is determined by a function f1 1515. Upon determination of a gambling game outcome 1516, an amount of RC 1518 is incremented or decremented and is displayed to the player in a gambling game user interface. The resultant change in RC results in a change in an attribute of EE 1510 via function f2 1520. However, in such an embodiment, it is not possible for the CE to undertake this AE (opening the door) without possession of a specific key (i.e. a game object) or if there is inadequate ambient lighting (i.e. a game state), or if the CE's health points are too low (i.e. the characteristic of the CE).

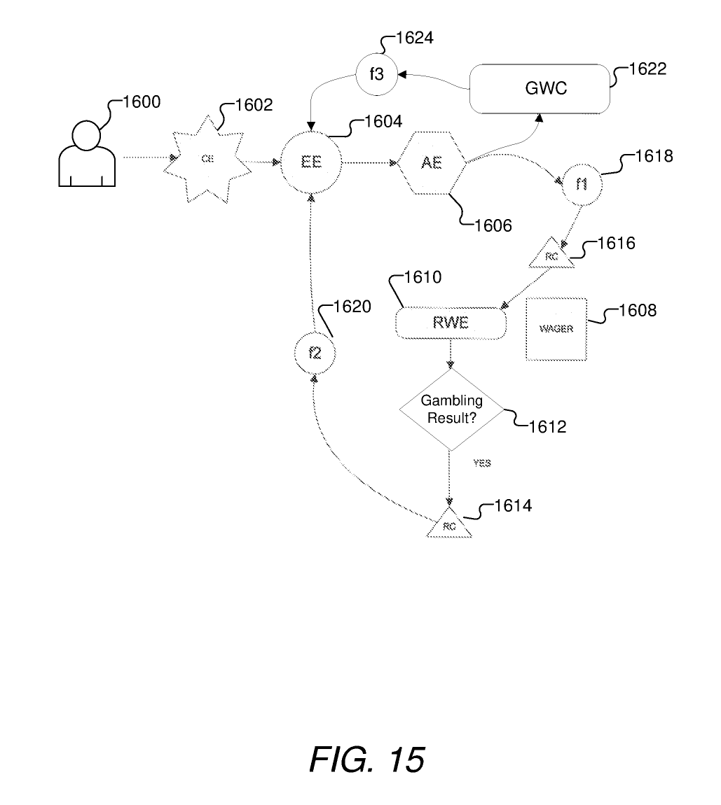

FIG. 15 is a flow chart illustrating another use of a controlled entity in accordance with an embodiment of the invention. In FIG. 15, a player 1600, using an entertainment game user interface, instructs a controlled entity 1602 as part of gameplay of a controlled entity hybrid game. The controlled entity 1602 consumes an entertainment game element, such as EE 1604. This in turn causes an AE 1606 to take place, which in turn triggers a wager 1608 in an real world engine subcontroller 1610. The gambling game outcome 1612 then creates as output a change in the amount of RC 1614 that is displayed to the player in a gambling game user interface and a change in the amount of the EE 1604. The amount of RC 1616 committed to the wager is a function (f1) 1618 of the AE 1606 in this case, and the result of the wager, if positive, generates RC 1614. The gambling game outcome also, by function f2 1620, determines a further change in an attribute of EE 1604. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface.

In still further embodiments, the nature, character, type or attributes of an EE may be changed. Entertainment game play causes game world credit (GWC) 1622 to be accumulated when certain events take place, achievements won, enemies vanquished, laps driven, etc., all examples of AE. In some embodiments, a feedback loop between GWC 1622 and EE 1604 exists such that the amount of EE related to the consumption of the CE 1602 is altered as a function of f3 1624, where f3 takes as an (and in some cases its only) argument the amount of GWC or the change in GWC or an entertainment game result.

In one embodiment, a racing game is implemented using a controlled entity hybrid game, where the car is CE, gasoline is EE, and each km driven is an AE. Gambling game wagers, and the commitment of RC are initiated for each AE (km driven). The result of the wager drives a change in RC, and through f2 may alter the amount of EE available to the car (CE). The skill demonstrated by the player through control of his/her CE over that period drives a change in GWC (e.g. driving a km under a certain time generates more GWC, crashing less adds to GWC, etc.), which in turn, via f3, causes additional EE (i.e. gas) to be accumulated, independent of the gambling game outcome.

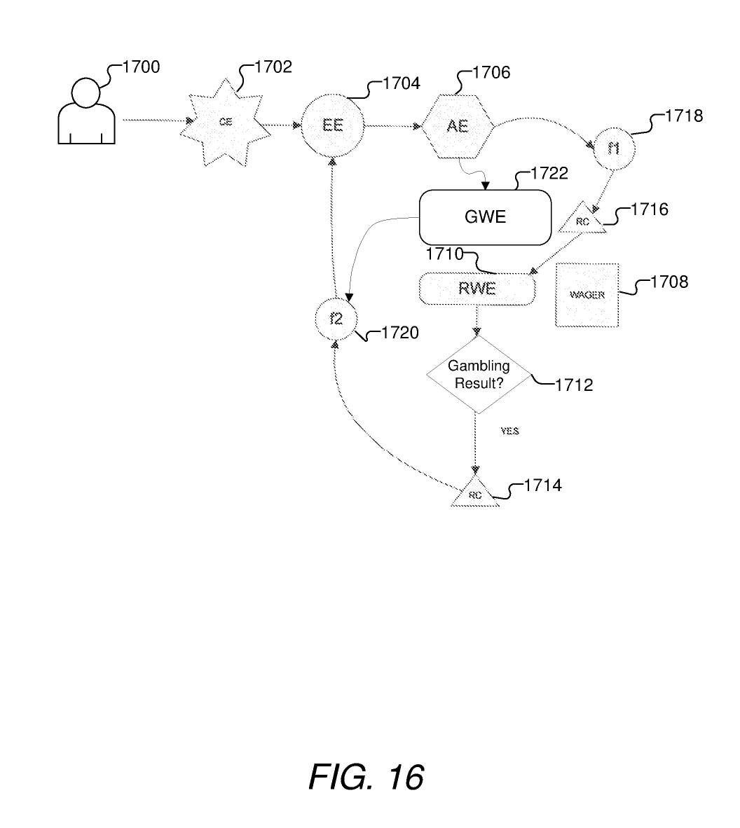

FIG. 16 is a flow chart illustrating another use of a controlled entity in accordance with an embodiment of the invention. In FIG. 16, a player 1700, using an entertainment game user interface, instructs a controlled entity 1702 as part of gameplay of an entertainment of a game controlled entity hybrid game. The controlled entity 1702 consumes an entertainment game element, such as EE 1704. This in turn causes an AE 1706 to take place, which in turn triggers a wager 1708 in an real world engine subcontroller 1710. The gambling game outcome 1712 then creates as output a change in the amount of RC 1714 that is displayed to the player in a gambling game user interface and a change in the amount of the EE 1704. The amount of RC 1716 committed to the wager is a function (f1) 1718 of the AE 1706 in this case, and the result of the wager, if positive, generates RC 1714. The gambling game outcome, by function f2 1720, also determines a further change in an attribute of EE 1704. In various embodiments, an amount of EE may be incremented on a positive gambling game outcome, or an amount of EE may be decremented on a positive gambling game outcome, or an amount of EE may be incremented on a negative gambling game outcome, or an amount EE may be decremented. The change in EE is displayed to the player in the entertainment game user interface. A function, f2 1720, may also alter the amount of EE 1704 as a function both of the output of the gambling game, and also the amount of GWC 1722, the change in GWC, or an entertainment game result or a multitude of these factors. Any change in GWC is displayed to the player in the entertainment game user interface.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An electronic gaming machine for a hybrid game having an entertainment game and an entertainment game, comprising:
a processor; and
a memory coupled to the processor, the memory having processor-executable instructions that when executed by the processor, cause the processor to:
generate an entertainment user interface for the entertainment game for the hybrid game;
determine an action taken by a controlled entity of the entertainment game as instructed by a player using the entertainment game user interface;
determine a gambling game outcome using a random number generator for a wager of real world credit in the gambling game in response to the action taken by the controlled entity;
generate a display of the gambling game outcome in a gambling game user interface for the gambling game of the hybrid game;
determine a change in an attribute of an element of the entertainment game using the gambling outcome;
generate a display in the entertainment game user interface of the change in the attribute of the element of the entertainment game; and
execute the entertainment game based upon actions taken by the game world character instructed by the player using the element.

2. The electronic gaming machine for a hybrid game having an entertainment game and an entertainment game of claim 1, wherein the element of the entertainment game is the controlled entity.

3. The electronic gaming machine for a hybrid game having an entertainment game and an entertainment game of claim 1, wherein the element of the entertainment game is an enabling element, and wherein the attribute is an amount of the enabling element.

4. The electronic gaming machine for a hybrid game having an entertainment game and an entertainment game of claim 3, wherein the change in the attribute is an increment in the amount of the enabling element on a positive gambling game outcome.

5. The electronic gaming machine for a hybrid game having an entertainment game and an entertainment game of claim 3, wherein the change in the attribute is an increment in the amount of the enabling element on a negative gambling game outcome.

6. The electronic gaming machine for a hybrid game having an entertainment game and an entertainment game of claim 3, wherein the change in the attribute is a decrement in the amount of the enabling element on a positive gambling game outcome.

7. The electronic gaming machine for a hybrid game having an entertainment game and an entertainment game of claim 3, wherein the change in the attribute is a decrement in the amount of the enabling element on a negative gambling game outcome.

8. The electronic gaming machine for a hybrid game having an entertainment game and an entertainment game of claim 1, wherein the element of the entertainment game is an actionable element, and wherein the change in the attribute is a restoration of the actionable element.

9. The electronic gaming machine for a hybrid game having an entertainment game and an entertainment game of claim 1, wherein the element of the entertainment game is an actionable element, and wherein the change in the attribute is a removal of the actionable element.

10. The electronic gaming machine for a hybrid game having an entertainment game and an entertainment game of claim 1, wherein the element of the entertainment game is a collective enabling element.

11. The electronic gaming machine for a hybrid game having an entertainment game and an entertainment game of claim 10, wherein the change in the attribute is a restoration of the collective enabling element.

12. The electronic gaming machine for a hybrid game having an entertainment game and an entertainment game of claim 10, and wherein the change in the attribute is a removal of the collective enabling element.
